(19) United States
(12) Patent Application Publication
(10) Pub. No.: US 2022/0051314 A1
(43) Pub. Date: Feb. 17, 2022

(54) INFORMATION PROCESSING APPARATUS, INFORMATION PROCESSING SYSTEM, MEMBER IDENTIFICATION METHOD, AND NON-TRANSITORY COMPUTER READABLE MEDIUM STORING PROGRAM

(71) Applicant: NEC Corporation, Minato-ku, Tokyo (JP)

(72) Inventor: Batnyam ENKHTAIVAN, Tokyo (JP)

(73) Assignee: NEC Corporation, Minato-ku, Tokyo (JP)

(21) Appl. No.: 17/274,621

(22) PCT Filed: Sep. 12, 2018
(86) PCT No.: PCT/JP2018/033842

§ 371 Date: Mar. 9, 2021

(51) Int. Cl. G06Q 30/08; H04L 9/32; H04L 9/08

(52) U.S. Cl. CPC G06Q 30/08; H04L 9/0825; H04L 9/3255

(57) ABSTRACT

An information processing device, an information processing system, a member identification method, and a program capable of preventing a member that has created an anonymous electronic signature from being arbitrarily identified from this signature are provided. A disclosure device (3) includes: a receiver (6) configured to receive signature information, which is information that constitutes an anonymous electronic signature; an identification information generation unit (7) configured to generate identification information, which is information for identifying a member that has created the anonymous electronic signature, based on the signature information; a storage unit (8) configured to store the number of times the identification information is generated by the identification information generation unit (7); and a transmitter (9) configured to transmit the identification information.

### TECHNICAL FIELD

The present disclosure relates to an information processing device, an information processing system, a member identification method, and a non-transitory computer readable medium storing a program, and in particular, an electronic auction.

### BACKGROUND ART

In modern society, electronic auctions have been actively held. One of these auctions that has been widely conducted is an English auction. In an English auction, bids are solicited from potential buyers for an item for a certain period of time. During the auction, the bids are disclosed, the potential buyers make bids while the bids increase, and a buyer who has made the highest bid wins the bidding.

In the English auction, it is important to give bidders anonymity in order to prevent frauds by participants or organizers. The frauds carried out by participants include, for example, collusion among participants. Without anonymity, who is bidding on what price can be known, which enables participants in collusion to monitor one another to successfully carry out collusion. The frauds carried out by organizers may include a situation in which an organizer is able to find out payment abilities of participants other than the successful bidder by knowing the bids made by these participants. Further, if the history of the bids made by the participants is known to the organizer, the bidding strategies of the participants may be leaked.

In order to avoid the above risks, roles of an organizer (i.e., management of an auction and identification of participants) are typically dispersed to different entities. One suitable technique for achieving this is a group signature that enables anonymous authentication.

Non-Patent Literature 1 proposes an English auction that uses a group signature. In Non-Patent Literature 1, an auction manager and a manager of disclosure (manager of revocation) of participant information are introduced. The auction manager manages registration of participants, bidding and the like. After the auction is ended, the disclosure manager discloses information on the successful bidder.

Non-Patent Literature 2 discloses a zero-knowledge proof data creation method and a verification method used in the group signature system proposed in Non-Patent Literature 1.

Non-Patent Literature 3 discloses a method of creating zero-knowledge proof data that constitutes a group signature.

Further, a method of achieving an anonymous auction system having an auction manager and a disclosure manager (registration manager) similar to those stated above by a method other than the group signature is also proposed in Non-Patent Literature 4. According to Non-Patent Literature 4, an auction participant registers a verification key that corresponds to a signature key in a registration manager, and the registration manager discloses information obtained by performing secret conversion on a public key of an auction participant. The auction manager then discloses information obtained by performing further secret conversion on the disclosed information. The auction participant searches for information on himself/herself from the information that the auction manager has disclosed, generates a signature, and makes a bid. In this system, the disclosure manager manages verification keys of the users, which makes it impossible for the auction manager to identify the signature creators.

In any one of a system that uses the group signature and a system that does not use the group signature, the user can be identified by using a private key of the disclosure manager set in a first stage of setting up parameters.

Besides the aforementioned techniques, a technique regarding anonymity in an auction includes a technique disclosed in Patent Literature 1. While Patent Literature 1 mentions that anonymity of a buyer is important, according to the technique proposed in this document, it is communication between a seller and a buyer that is anonymized. Specifically, a mail server that filters addresses from which emails are transmitted is provided so that the seller and the buyer can transmit emails anonymously. Therefore, a message to be sent to the administrator is not made anonymous in the technique disclosed in Patent Literature 1, and the anonymity to the administrator is not discussed.

### CITATION LIST

### Patent Literature

[Patent Literature 1] Japanese Unexamined Patent Application Publication No. 2001-195511

### Non-Patent Literature

[Non-Patent Literature 1] Khanh Quoc Nguyen and Jacques Traore, “An Online Public Auction Protocol Protecting Bidder Privacy”, 2000, ACISP 2000, LNCS 1841, pp. 427-442.
[Non-Patent Literature 2] Jan Camenisch, “Efficient and Generalized Group Signatures”, 1997, EUROCRYPT '97, LNCS 1233, pp. 465-479.
[Non-Patent Literature 3] Jan Camenisch and Markuc Stadler, “Efficient Group Signature Schemes for Large Groups”, 1997, CRYPTO '97, pp. 410-424.
[Non-Patent Literature 4] Kazumasa Omote and Atsuko Miyaii, “A Practical English Auction with One-time Registration”, 2001, Proceedings of ACISP2001, pp. 221-234.

### SUMMARY OF INVENTION

### Technical Problem

As described above, the auction manager cannot identify the creator of the signature unless he/she acquires the private key of the disclosure manager. However, if the identification of the signature creator by the disclosure manager and the notification of the results of the identification are arbitrarily performed, it is possible that the disclosure manager may identify signature creators without any limitation.

The present disclosure has been made in order to solve the above problem and aims to provide an information processing device, an information processing system, a member identification method, and a program capable of preventing the member that has created the anonymous electronic signature from being arbitrarily identified from this signature.

### Solution to Problem

An information processing device according to a first aspect of the present disclosure includes:

reception means for receiving signature information, which is information that constitutes an anonymous electronic signature;

identification information generation means for generating identification information, which is information for identifying a member who has created the anonymous electronic signature, based on the signature information;

storage means for storing the number of times the identification information is generated by the identification information generation means; and

transmission means for transmitting the identification information.

An information processing system according to a second aspect of the present disclosure includes:

a management device that receives bid information with an anonymous electronic signature and manages bidding by an electronic auction and a disclosure device that identifies a participant device that is a member that has created the anonymous electronic signature, wherein

the management device comprises:

a first transmission means for transmitting, to the disclosure device, signature information, which is information that constitutes the anonymous electronic signature granted to the bid information regarding which the participant device which has transmitted the bit information should be identified among the pieces of bid information that have been received; and

a first reception means for receiving, from the disclosure device, identification information, which is information for identifying the participant device that has created the anonymous electronic signature,

the disclosure device comprises:

a second reception means for receiving the signature information from the management device;

identification information generation means for generating the identification information based on the signature information received by the second reception means;

storage means for storing the number of times the identification information is generated by the identification information generation means; and

a second transmission means for transmitting the identification information to the management device.

In a member identification method according to a third aspect of the present disclosure,

an information processing device performs processing of:

receiving signature information, which is information that constitutes an anonymous electronic signature;

generating, based on the signature information, identification information, which is information for identifying a member that has created the anonymous electronic signature;

storing the number of times the identification information is generated; and transmitting the identification information.

A program according to a fourth aspect of the present disclosure causes a computer to execute the following steps of:

a receiving step for receiving signature information, which is information that constitutes an anonymous electronic signature;

an identification information generation step for generating identification information, which is information for identifying a member that has created the anonymous electronic signature based on the signature information;

a storing step for storing the number of times the identification information is generated; and

a transmission step for transmitting the identification information.

### Advantageous Effects of Invention

According to the present disclosure, it is possible to provide an information processing device, an information processing system, a member identification method, and a program capable of preventing the member that has created the anonymous electronic signature from being arbitrarily identified from this signature.

### BRIEF DESCRIPTION OF DRAWINGS

FIG. 1 is a diagram showing constituents in a group signature system for each role;

FIG. 2 is a diagram showing a procedure for generating a group signature;

FIG. 3 is a block diagram showing one example of a configuration of an information processing system 1 according to an outline of example embodiments;

FIG. 4 is a diagram showing one example of a configuration of an auction system 11 according to the first example embodiment;

FIG. 5 is a block diagram showing one example of a configuration of a manager device 10 according to the first example embodiment;

FIG. 6 is a block diagram showing one example of a hardware configuration of the manager device 10 according to the first example embodiment;

FIG. 7 is a block diagram showing one example of a configuration of a trusted hardware 20 according to the first example embodiment;

FIG. 8 is a block diagram showing one example of a configuration of a participant device 30 according to the first example embodiment;

FIG. 9 is a sequence diagram showing one example of a setup operation in the auction system 11 according to the first example embodiment;

FIG. 10 is a sequence diagram showing one example of a bidding operation in the auction system 11 according to the first example embodiment;

FIG. 11 is a sequence diagram showing one example of an operation of identifying a bidder in the auction system 11 according to the first example embodiment;

FIG. 12 is a block diagram showing one example of a configuration of a trusted hardware 40 according to a second example embodiment;

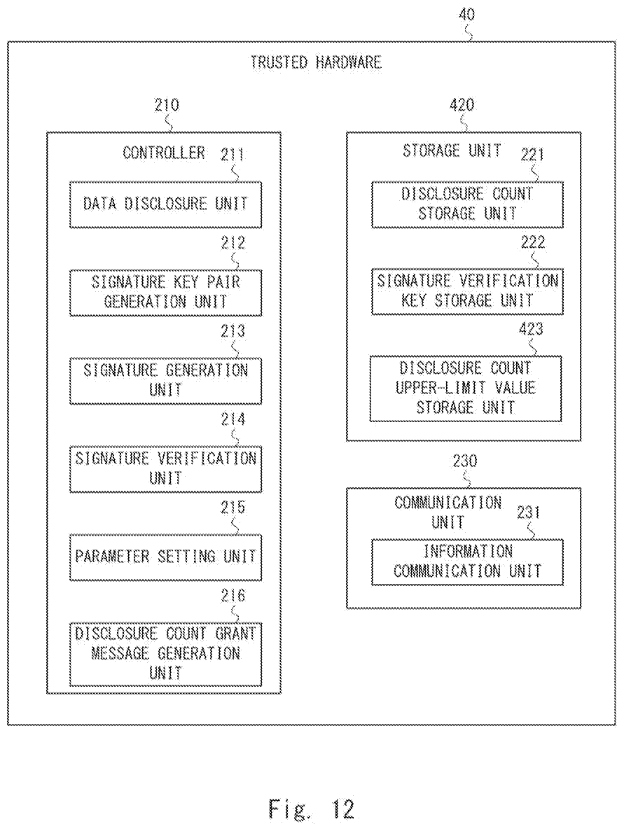

FIG. 13 is a sequence diagram showing one example of a setup operation of an auction system according to the second example embodiment;

FIG. 14 is a sequence diagram showing one example of an operation of identifying a bidder in the auction system according to the second example embodiment;

FIG. 15 is a diagram showing one example of a configuration of an auction system 13 according to a third example embodiment;

FIG. 16 is a block diagram showing one example of a configuration of a manager device 50 according to the third example embodiment;

FIG. 17 is a block diagram showing one example of a configuration of an information sharing server 60 according to the third example embodiment;

FIG. 18 is a block diagram showing one example of a configuration of a participant device 70 according to the third example embodiment;

FIG. 19 is a sequence diagram showing one example of a setup operation of the auction system 13 according to the third example embodiment;

FIG. 20 is a sequence diagram showing one example of a bidding operation in the auction system 13 according to the third example embodiment;

FIG. 21 is a diagram showing one example of a configuration of an auction system 14 according to a fourth example embodiment;

FIG. 22 is a block diagram showing one example of a configuration of a manager device 100 according to the fourth example embodiment;

FIG. 23 is a block diagram showing one example of a configuration of a participant device 90 according to the fourth example embodiment;

FIG. 24 is a sequence diagram showing one example of a setup operation of an auction system 14 according to the fourth example embodiment;

FIG. 25 is a sequence diagram showing one example of a bidding operation in the auction system 14 according to the fourth example embodiment; and

FIG. 26 is a sequence diagram showing one example of an operation of identifying the bidder in the auction system 14 according to the fourth example embodiment.

### DESCRIPTION OF EMBODIMENTS

For the sake of clarification of the description, the following descriptions and the drawings will be omitted and simplified as appropriate. Throughout the drawings, the same components are denoted by the same reference symbols and the overlapping descriptions will be omitted as appropriate.

As described above, ensuring anonymity of participants in an auction leads to prevention of various frauds by bidders or auction organizers. In order to facilitate understanding of example embodiments, first, as one example, a description of an English auction will be given, and problems in this English auction will be described.

An administrator of an English auction updates the highest price upon confirming that a bid message received from a bidder has been created by a legitimate creator and the bid is higher than the current highest price. At this time, the administrator does not need to know which of the auction participants has created the hid message. The administrator needs to identify a bidder only when the successful bidder should be identified after the auction ends or when a participant who makes a fraudulent bid needs to be identified. Further, in view of the purpose of an auction, there is no need to associate a plurality of bid messages that have been created by one participant with one another. It is sufficient that the administrator know the person who eventually wins the bidding.

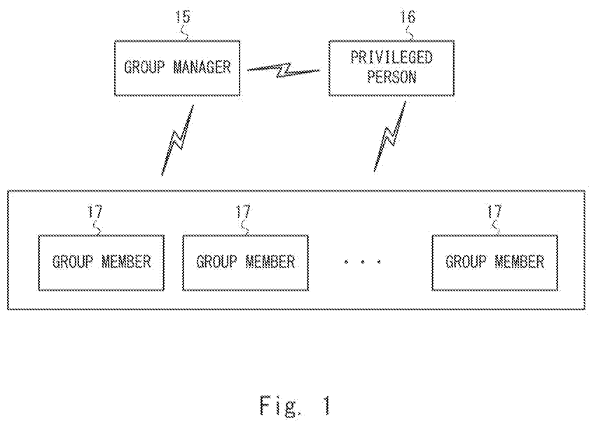

Therefore, a system for anonymizing a bidder using a group signature system in the English auction has been proposed. Since the details of the group signature are disclosed in Non-Patent Literature 2, only the outline thereof will be described here. The group signature system is a type of an anonymous electronic signature. The anonymous electronic signature is an electronic signature used for anonymous authentication. The group signature system is cryptography for hiding the identity of a person who has signed one message while verifying that the person who has signed belongs to a group. FIG. 1 is a diagram showing constituents in the group signature system for each role. As shown in FIG. 1, a group manager 15, a privileged person 16, and group members 17 are in this system.

The group manager 15 and the privileged person 16 set and disclose parameters used to create the group signature. Each of the group member 17 generates his/her own confidential information based on the disclosed information and registers the generated confidential information in the group manager 15. The registration is performed in such a way that only the privileged person 16 can identify the group member 17 from the group signature created by the group member 17. Accordingly, the group manager 15 is able to verify that the group signature has been created by the group member 17. More specifically, the following operations are performed.

First, a setup operation will be described. The initial setting is performed. by the setup operation shown by the following procedure.

1. The group manager 15 sets parameters for creating the group signature and discloses parameters other than a private key for the administrator. The private key for the administrator is used to create a member certificate that is issued when members are registered,

2. Based on the parameters disclosed by the group manager 15, the privileged person 16 creates a private key for the privileged person and a public key for the privileged person and discloses the public key for the privileged person. The private key for the privileged person is used to identify the group member 17 in a later process.

3. Each of the group members 17 generates his/her own public key for a group member and private key for a group member based on the parameters disclosed by the administrator. Then the group member 17 transmits the public key for the group member to the group manager 15. The private key for the group member is used to create the group signature in a later process.

4. The group manager 15 creates a member certificate for each member using the private key for the group manager based on the received public key for the group member, and transmits the created member certificate to the group member 17. The group manager 15 registers and stores the public key for the group member and the ID of the group member who has created this key. This registered information is used to identify the group member 17 who has created the group signature from the group signature in a later process.

The registration of the group member is thus completed.

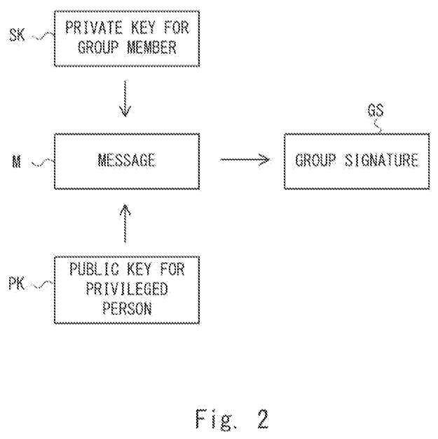

Next, with reference, to FIG. 2, an operation of creating a group signature by a group member will be described. FIG. 2 is a diagram showing a procedure for generating a group signature. As shown in FIG. 2, the group member 17 creates a group signature GS based on his/her private key for the group member SK, a public key for the privileged person PK, and a message M to be signed. In this signature, it is indicated by zero-knowledge proof that the group member 17 owns the member certificate issued from the group manager 15. Anyone can verify the validity of the group signature GS based on the disclosed information.

Last, an operation of identifying the group member 17 who has created the group signature GS based on the group signature GS will be described. The identification of the group member 17 will be performed in the following procedure.

1. Only the privileged person 16 who has the private key for the privileged person can identify the creator from the group signature GS. The privileged person 16 is able to calculate the public key for the group member of the group member 17 who has created the group signature GS or information that can be calculated from this public key using the group signature GS and the private key for the privileged person. Then the privileged person 16 passes the results of the calculation to the group manager 15.

2. The group manager 15 identifies the ID of the group member 17 who has created the group signature GS from the received information, and the recording of the public key for the group member and the ID of the group member 17 the group manager 15 holds.

Described above is the outline of the group signature system.

As described above, in the group signature system, the group member 17 cannot be identified by only one of the group manager 15 and the privileged person 16, and therefore the group signature system is suitable to protect the privacy of the participants in the English auction system. For example, the group manager 15 serves as an auction manager who performs operation of the auction and the privileged person 16 serves as a disclosure manager who identifies the successful bidder from a group signature attached to a bid message, whereby the English auction can be operated. The participant who is the group member 17 attaches a group signature to a bid message, as described above, whereby it is possible for the participant to show the administrator that he/she is a legitimate participant while maintaining anonymity.

It apparently seems, from the above discussion, that the operation of an auction may be established while protecting the privacy of the auction participants. However, if the identification of the signature creator by the privileged person 16 and the notification of the result of the identification are arbitrarily performed, the organizer of the auction is able to identify every participant who has made a bid. The same is also true in a case in which the private key for the privileged person is leaked. As a result, the privacy of the auction participants is significantly violated. For example, as described above, a strategy for bidding can be read out from the bidding history of the participants. It is also possible that bidding of a specific participant may be obstructed. Further the payment ability of a participant may be revealed from a bid that the participant has last made. Further, if these information pieces are leaked to other participants, the privacy may be further violated.

In view of the above, a technique for preventing the member who has created an anonymous electronic signature such as a group signature from being arbitrarily identified from this signature has been required.

<Outline of Example Embodiments>

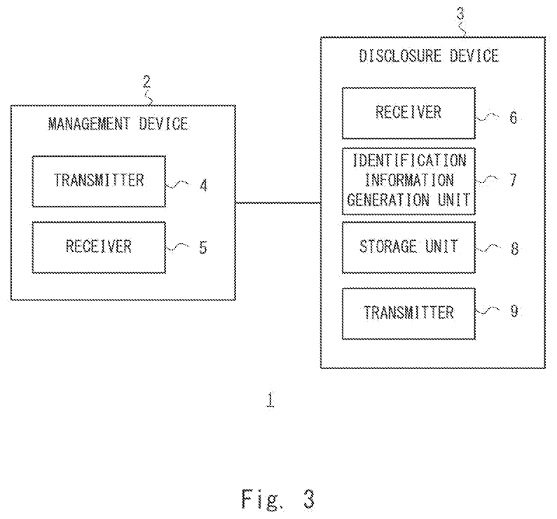

Prior to giving the description of example embodiments, the outline of the example embodiments will be described first. FIG. 3 is a block diagram showing one example of a configuration of an information processing system 1 according to the outline of the example embodiments. As shown in FIG. 3, an information processing system 1 includes a management device 2 and a disclosure device 3. The management device 2 and the disclosure device 3 may be referred to as an information processing device.

The management device 2 is a device that receives bid information with an anonymous electronic signature and manages bidding by an electronic auction. The management device 2 corresponds to the group manager 15 in FIG. 1. The management device 2 includes a transmitter 4 and a receiver 5.

The transmitter 4 transmits, to the disclosure device 3, signature information, which is information that constitutes an anonymous electronic signature which has been granted to the bid information regarding which the participant device (not shown in FIG. 3) that has transmitted the above bid information should be identified among the received pieces of bid information. That is, in order to identify the participant device that has created the anonymous electronic signature, the transmitter 4 transmits the signature information to the disclosure device 3.

The receiver 5 receives identification information from the disclosure device 3. The identification information is information for identifying the participant device that has created the anonymous electronic signature, and corresponds to group signature creator specifying information that will be described later. That is, the receiver 5 receives the result of the identification of the signature creator by the disclosure device 3.

The disclosure device 3 is a device for identifying the participant device that is the member that has created the anonymous electronic signature. The disclosure device 3 corresponds to the privileged person 16 shown in FIG. 1. The disclosure device 3 includes a receiver 6, an identification information generation unit 7 a storage unit 8, and a transmitter 9.

The receiver 6 receives the signature information, which is information that constitutes the anonymous electronic signature, from the management device 2. That is, the receiver 6 receives the signature information regarding the anonymous electronic signature regarding which identification of the signature creator has been required, the signature information being transmitted from the transmitter 4 of the disclosure device 3.

The identification information generation unit 7 generates the identification information for identifying the participant device that has created the anonymous electronic signature based on the signature information received by the receiver 6. The identification information generation unit 7 generates the identification information using, for example, the received signature information and the private key that the disclosure device 3 includes in advance. The specific method of generating the identification information depends on the anonymous electronic signature system. The identification information generation unit 7 may generate the identification information by performing the calculation in accordance with a known identification method of the creator of the anonymous electronic signature using the received signature information (the anonymous electronic signature) and the private key that the disclosure device 3 includes in advance.

The storage unit 8 stores the number of times the identification information is generated. The storage unit 8 stores the number of times of generation in, for example, a storage device such as a memory or a storage. The storage unit 8 increments a value stored as the number of times of generation by one every time the identification information is generated by the identification information generation unit 7.

The transmitter 9 transmits the identification information generated by the identification information generation unit 7 to the management device 2. Accordingly, the receiver 5 of the management device 2 receives the result of identifying the signature creator. That is, accordingly, the management device 2 is able to check by which one of the participant devices the anonymous electronic signature has been generated.

As described above, in the information processing system 1, the storage unit 8 stores the number of times the identification information is generated. Therefore, it becomes possible to manage the number of times the participant device that has created the anonymous electronic signature has been identified. Therefore, it is possible to prevent the member that has created the anonymous electronic signature from being arbitrarily identified from this signature. While the information processing system 1 that includes the management device 2 in addition to the disclosure device 3 has been illustrated in FIG. 3, other example embodiments may be achieved as well. It is needless to say, for example, that an example embodiment that does not include the management device 2, that is, an example embodiment in which the disclosure device 3 is focused on, may be achieved as well. Further, an example embodiment of a program or a method that performs the above processing in the disclosure device 3 may be achieved as well. In these example embodiments as well, the number of times the identification information is generated is stored, whereby it is possible to prevent the member that has created the anonymous electronic signature from being arbitrarily identified from this signature.

### First Example Embodiment

Hereinafter, with reference to the drawings, the details of the example embodiments will be described. The following example embodiments will be described, taking an application to the English auction system as an example. However, the system to which this disclosure can be applied is not limited to the English anonymous auction system. Any system may be used as long as it is required to appropriately limit information that the administrator can obtain from data to be managed while verifying validity of this data. For example, besides the English auction in which the bids increase, a Dutch auction system in which the bids decrease corresponds to the above conditions. The present application may be applied not only to an open bidding system like an English auction or a Dutch auction in which bids are open but also to an auction system of a sealed bid system. The bidding system of the sealed bid system also corresponds to the above requirements since there is no need to identify bids of participants other than the successful bidder although the administrator needs to identify a successful bidder while verifying the validity of the bidding for every bid. As described above, the present disclosure may be applied to, for example, a desired electronic auction where anonymity of bidding is required.

### (Outline of System Configuration)

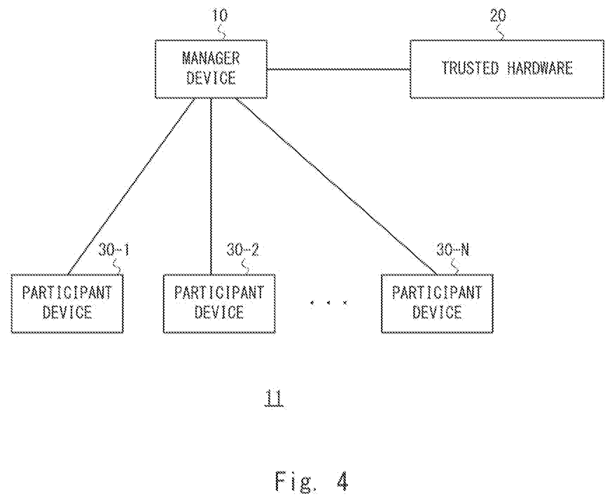

FIG. 4 is a diagram showing one example of a configuration of an auction system 11 according to the first example embodiment. Referring to FIG. 4, the auction system 11 is configured to include a manager device 10, a trusted hardware 20, and participant devices 30-1 to 30-N (N is an integer, the same is applied below). In the following description, when there is no need to particularly differentiate the participant devices 30-1 to 30-N, each of them is simply referred to as a “participant device 30”. The manager device 10 and the participant device 30 are connected to each other via a network such as the Internet. Further, the manager device 10 and the trusted hardware 20 are also connected to each other via a network such as the Internet. Note that the trusted hardware 20 and the participant device 30 may also be connected to each other via a network such as the Internet.

### (Manager Device 10)

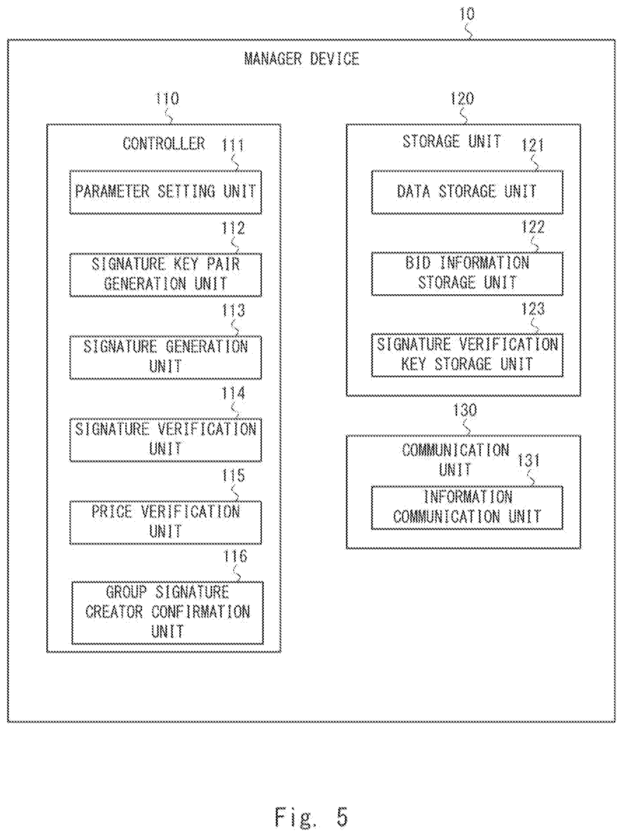

The manager device 10 is a device that is owned by, for example, the administrator of the auction and is used for performing preparation and management of the auction. The manager device 10, which corresponds to the management device 2 shown in FIG. 3, is an example of a device of receiving bid information with an anonymous electronic signature and manages bidding by an electronic auction. FIG. 5 is a block diagram showing one example of a configuration of the manager device 10. As shown in FIG. 5, the manager device 10 includes a controller 110, a storage unit 120, and a communication unit 130. Each of these components is achieved by, for example, a computer such as a desktop personal computer, a laptop personal computer, a workstation, a tablet, or a smartphone executing a program.

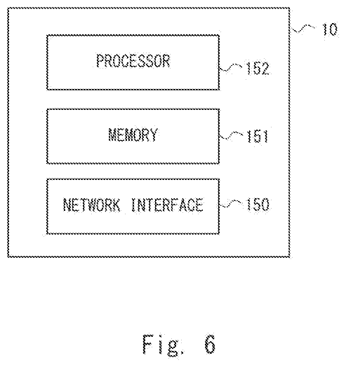

Therefore, the manager device 10 includes, for example, a hardware configuration as shown in FIG. 6. That is, as shown in FIG. 6, the manager device 10 includes a network interface 150, a memory 151, and a processor 152. As will be described later, the configuration shown in FIG. 6 is understood as the configuration of the trusted hardware 20 and the participant device 30 as well.

The network interface 150 is used to communicate with another device. The network interface 150 may include, for example, a network interface card (NIC).

The memory 151 is composed of, for example, a combination of a volatile memory and a non-volatile memory. The memory 151 is used to store software (computer program) or the like including one or more instructions executed by the processor 152. Further, the memory 151 is used as an area in which information is stored by the storage unit 120.

The processor 152 loads software (computer program) from the memory 151 and executes the loaded software (computer program), thereby performing the processing of the respective components shown in FIG. 5. The processor 152 may be, for example, a microprocessor, a Micro Processor Unit (MPU), or a Central Processing Unit (CPU). The processor 152 may include a plurality of processors.

Referring once again to FIG. 5, description of the respective components shown in FIG. 5 will be continued.

The controller 110 includes a parameter setting unit 111, a signature key pair generation unit 112, a signature generation unit 113, a signature verification unit 114, a price verification unit 115, and a group signature creator confirmation unit 116.

The parameter setting unit 111 sets parameters for creating the group signature used for the auction. The details of the parameters to be set will be described later.

The signature key pair generation unit 112 generates a key pair formed of a signature key for generating a digital signature and a verification key for verifying the generated digital signature.

The signature generation unit 113 generates the digital signature by the signature key that is generated by the signature key pair generation unit 112 and is owned by the manager device 10. By attaching the digital signature to the information that the manager device 10 transmits and verifying the digital signature using the verification key generated by the signature key pair generation unit 112 that the receiver side has acquired in advance, the receiver side is able to confirm that this information is the one created by the manager device 10.

The signature verification unit 114 verifies the digital signature created by the participant device 30 or the trusted hardware 20 and verifies the group signature created by the participant device 30. The signature verification unit 114 verifies the digital signature attached to the information transmitted by the participant device 30 using the verification key that has been generated by a signature key pair generation unit 311 of the participant device 30 that will be described later and has been stored by the manager device 10 in the signature verification key storage unit 123 in advance. Likewise, the signature verification unit 114 verifies the digital signature attached to the information transmitted by the trusted hardware 20 using the verification key that has been stored by the signature verification key storage unit 123 in advance and has been generated by a signature key pair generation unit 212 of the trusted hardware 20 that will be described later. The details of the verification of the group signature by the signature verification unit 114 will be described later.

The price verification unit 115 verifies, upon receiving a new bid message (a bid and a group signature), whether the placed bid is higher than the current highest price stored by the bid information storage unit 122. Further, when the bid is higher than the current highest price, the price verification unit 115 creates a message indicating an updating of the price (a message indicating the updated current highest price). In the following description, this message will be referred to as a price update message.

The group signature creator confirmation unit 116 identifies the ID of the creator of the group signature (ID of the participant device 30) using the information for identifying the creator of the group signature received from the trusted hardware 20 (hereinafter this information will be referred to as group signature creator specifying information). The group signature creator confirmation unit 116 identifies the ID that corresponds to the group signature creator specifying information based on the information stored by the data storage unit 121 and the group signature creator specifying information.

The storage unit 120 includes a data storage unit 121, a bid information storage unit 122, and a signature verification key storage unit 123.

The data storage unit 121 stores a pair of information received from the participant device 30 when the participant is registered in the group (described in the item of registration operation later) and the ID in a storage device such as the memory 151. The ID may be any one that can identify a member in the group in the group signature, and may be generated by the manager device 10, or may be generated by the participant device 30 and sent to the manager device 10. The ID may be an e-mail address, a telephone number, a character string, an image, a sound or the like.

The bid information storage unit 122 stores the bid message received from the participant device 30 in a storage device such as the memory 151.

The signature verification key storage unit 123 stores the verification key disclosed to verify digital signatures of the trusted hardware 20 and the participant device 30 in a storage device such as the memory 151. That is, the signature verification key storage unit 123 stores, in a storage device such as the memory 151, the verification keys for digital signature acquired from the trusted hardware 20 and the participant device 30 in advance before the start of the auction.

The communication unit 130 includes an information communication unit 131. The information communication unit 131 performs, using the network interface 150, communication with the trusted hardware 20 and the participant device 30 when a group is set up. Further, the information communication unit 131 performs reception of the bid message from the participant device 30, transmission/reception of the price update message to/from the trusted hardware 20, and transmission of the price update message to the participant device 30 using the network interface 150. The information communication unit 131 may execute the communication by wireless communication, execute communication by wired. communication, or execute the communication by a combination thereof. The information communication unit 131 corresponds to the transmitter 4 and the receiver 5 shown in FIG. 3.

### (Trusted Hardware 20)

The trusted hardware 20 is a device that serves as a disclosure manager in an auction by communication with the manager device 10 and limits the power of the auction manager. The trusted hardware 20, which corresponds to the disclosure device 3 shown in FIG. 3, is one example of a device for identifying the participant device 30, a member that has created the anonymous electronic signature. The trusted hardware 20 is a device composed as so-called trusted hardware.

In recent years, technology development for shifting a root-of-trust in the application of cryptography from humans to secure devices has been advancing. As a result, hardware that can securely generate a public key pair and storing generated encrypted data without leaking confidential information to the outside of devices has become commercially available. Such a device is called trusted hardware, meaning that it can be a root-of-trust, and includes, for example, Intel SGX or TrustZone available from ARM.

Therefore, the trusted hardware 20, which is a device that operates as programmed in advance, is a device that does not allow external unauthorized access to information stored therein. That is, the trusted hardware 20 is a device in which it is guaranteed in advance that it includes a mechanism for preventing leakage of data in the trusted hardware 20. While the trusted hardware is held by, for example, the auction manager, it may be held by a person other than the auction manager since the trusted hardware has a secure configuration as described above and thus safety thereof is ensured.

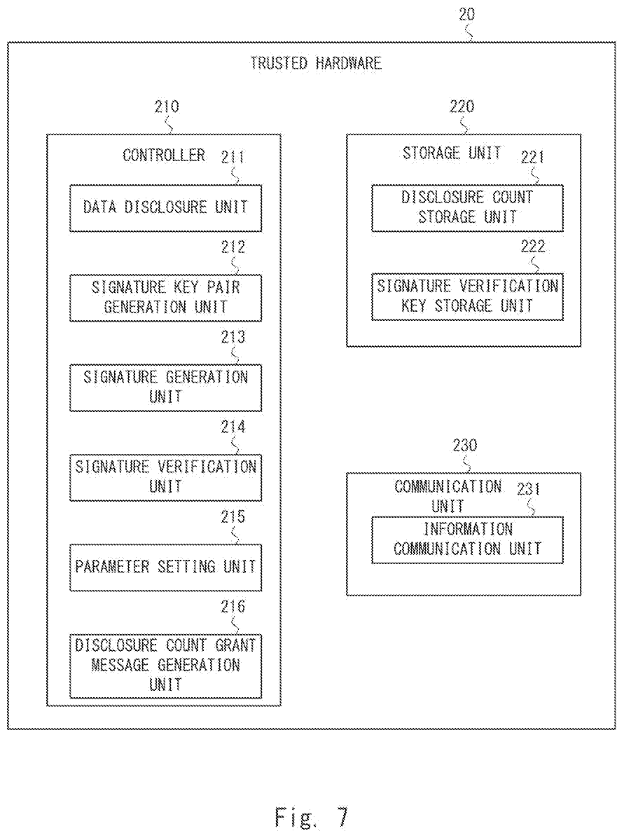

FIG. 7 is a block diagram showing one example of a configuration of the trusted hardware 20. As shown in FIG. 7, the trusted hardware 20 includes a controller 210, a storage unit 220, and a communication unit 230. These components are achieved by the trusted hardware 20 serving as a computer executing a program. That is, the trusted hardware 20 includes, for example, the configuration as shown in FIG. 6, like the manager device 10. Therefore, for example, the memory 151 of the trusted hardware 20 is used as an area in which information is stored by the storage unit 220. Further, the processor 152 of the trusted hardware 20 loads software (computer program) from the memory 151 of the trusted hardware 20 and executes the loaded software (computer program), thereby performing processing of the respective components shown in FIG. 7.

According to the aforementioned configuration, the trusted hardware 20 holds a private key of the disclosure manager that will be described later (this key corresponds to the “private key for the privileged person” described above) and discloses information that can identify the creator based on the group signature included in the bid message. The trusted hardware 20 further holds the value of the disclosure count counter that increases in accordance with the number of times of disclosure and attaches the value of the disclosure count counter to the message transmitted by the manager device 10.

The controller 210 includes a data disclosure unit 211, a signature key pair generation unit 212, a signature generation unit 213, a signature verification unit 214, a parameter setting unit 215, and a disclosure count grant message generation unit 216.

The data disclosure unit 211 corresponds to the identification information generation unit 7 in FIG. 3. The data disclosure unit 211 extracts, upon receiving a disclosure request message from the manager device 10, information from which it is possible to identify the creator (the participant device 30) based on the group signature included in the disclosure request message.

The signature key pair generation unit 212 generates a key pair formed of a signature key for generating the digital signature granted to the message transmitted from the trusted hardware 20 and a verification key for verifying the generated digital signature.

The signature generation unit 213 generates the digital signature to be applied to the message that the trusted hardware 20 transmits using the signature key generated by the signature key pair generation unit 212. The device that has received a message to which the digital signature has been applied verifies the digital signature using the verification key that has been generated by the signature key pair generation unit 212 and has been acquired in advance, thereby being able to confirm that this message has been created by the trusted hardware 20.

The signature verification unit 214 verifies the digital signature applied to the message received from the manager device 10 by the verification key received from the manager device 10 in advance. More specifically, the signature verification unit 214 verifies the digital signature attached to the information transmitted by the manager device 10 using the verification key that has been generated by the signature key pair generation unit 112 of the manager device 10 and has been stored by a signature verification key storage unit 222 of the trusted hardware 20 in the storage device in advance.

The parameter setting unit 215 generates a key pair for the disclosure manager (i.e., a public key Y_{R} and a private key ω of the disclosure manager generated in Step S105 that will be described later) based on the parameter received from the manager device 10. Note that the key pair for the disclosure manager corresponds to the private key for the privileged person and the public key for the privileged person described above.

After the trusted hardware 20 has received the price update message from the manager device 10, the disclosure count grant message generation unit 216 generates information (message) in which the received price update message is associated with the current counter value stored by a disclosure count storage unit 221. That is, this message includes the current price and the current counter value. This message is sent to the participant device 30 as the price update message.

The storage unit 220 includes a disclosure count storage unit 221 and a signature verification key storage unit 222.

The disclosure count storage unit 221 stores the count value for counting the number of times the trusted hardware 20 has disclosed information of the group signature creator (in other words, the number of times that the trusted hardware 20 has generated information of the group signature creator) in a storage device such as the memory 151. For the sake of simplification, it is assumed that the counter value of the number of times of disclosure starts from zero. The disclosure count storage unit 221 corresponds to the storage unit 8 shown in FIG. 3.

The signature verification key storage unit 222 stores the verification key disclosed to verify the digital signature of the manager device 10 (verification key generated by the signature key pair generation unit 112 of the manager device 10) in a storage device such as the memory 151.

The communication unit 230 includes an information communication unit 231. The information communication unit 231 performs communication between the trusted hardware 20 and the manager device 10 using the network interface 150. The information communication unit 231 may execute the communication by wireless communication, execute the communication by wired communication, or execute the communication by a combination thereof. The information communication unit 231 corresponds to the receiver 6 and the transmitter 9 shown in FIG. 3.

### (Participant Device 30)

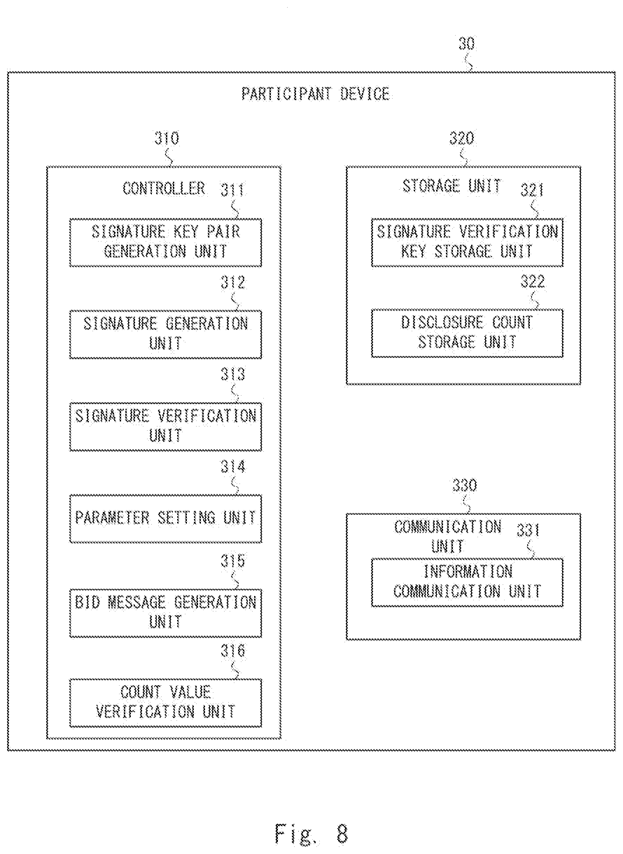

The participant device 30 is a device that is held, for example, by a participant who participates in the auction and is used to make a bid. FIG. 8 is a block diagram showing one example of a configuration of the participant device 30. As shown in FIG. 8, the participant device 30 includes a controller 310, a storage unit 320, and a communication unit 330. These devices are achieved, for example, by a computer such as a desktop personal computer, a laptop personal computer, a workstation, a tablet, or a smartphone executing a program. That is, the respective parts shown in FIG. 8 are achieved by the participant device 30 serving as a computer executing a program. That is, the participant device 30 includes the configuration shown in, for example, FIG. 6, like the manager device 10. Therefore, for example, the memory 151 of the participant device 30 is used as an area in which information is stored by the storage unit 320. Further, the processor 152 of the participant device 30 loads software (computer program) from the memory 151 of the participant device 30 and executes the loaded software (computer program), thereby performing processing of the respective components shown in FIG. 8.

The controller 310 includes a signature key pair generation unit 311, a signature generation unit 312, a signature verification unit 313, a parameter setting unit 314, a bid message generation unit 315, and a count value verification unit 316.

The signature key pair generation unit 311 generates a signature key for generating a digital signature granted to the communication content in communication that the participant device 30 performs with the manager device 10 before the auction starts, and a verification key for verifying the generated digital signature.

The signature generation unit 312 performs generation of the digital signature and generation of the group signature applied to the bid message. The signature generation unit 312 generates the digital signature using the signature key generated by the signature key pair generation unit 311. The group signature is formed of a plurality of pieces of zero-knowledge proof data that cannot be created without knowing the private key for the member. While the specific configuration method will be described later, the signature generation unit 312 creates the zero-knowledge proof data, that is, the group signature using the private key for the member and the public key for the group signature.

The signature verification unit 313 verifies the digital signature of the manager device 10 or the trusted hardware 20 included in the message from the manager device 10. The signature verification unit 313 performs verification using the verification key generated by the signature key pair generation unit 112 of the manager device 10 or the verification key generated by the signature key pair generation unit 212 of the trusted hardware 20.

The parameter setting unit 314 generates a participant key pair based on the parameter received from the manager device 10. The participant key pair corresponds to the public key for the group member and the private key for the group member described above.

The bid message generation unit 315 generates bid information of the electronic auction, that is, information indicating the bid. The bid message generation unit 315 generates, for example, a message indicating the price instructed by an input operation or the like from the user as a bid.

The count value verification unit 316 verifies whether or not unauthorized. identification of a signer has been conducted based on the count value applied to the price update message. Specifically, the count value verification unit 316 determines whether or not the count values granted to the respective price update messages received by the participant devices 30 during an auction from the start of bidding to successful bid are the same, thereby verifying the count value. When these count values are the same, the count value verification unit 316 determines that unauthorized identification of the signer has not been performed.

The storage unit 320 includes a signature verification key storage unit 321 and a disclosure count storage unit 322.

The signature verification key storage unit 321 stores the verification key disclosed to verify the digital signature of the manager device 10 and the verification key disclosed to verify the digital signature of the trusted hardware 20 in a storage device such as the memory 151. That is, the signature verification key storage unit 321 stores the verification key generated by the signature key pair generation unit 112 of the manager device 10 and the verification key generated by the signature key pair generation unit 212 of the trusted hardware 20.

The disclosure count storage unit 322 stores the count value of the number of times of disclosure that the trusted hardware 20 grants to a price update message that will be described later in a storage device such as the memory 151. For the sake of simplification, the disclosure count storage unit 322 stores zero as an initial value.

The communication unit 330 includes an information communication unit 331. The information communication unit 331 performs communication between the participant device 30 and the manager device 10 using the network interface 150. The information communication unit 331 may perform communication by wireless communication or by wired communication, or perform communication by a combination thereof.

### (Description of Operations)

Next, with reference to the drawings, schematic operations of the auction system 11 including the manager device 10, the trusted hardware 20, and the participant device 30 will be described. It is assumed here that the manager device 10, the trusted hardware 20, and the participant device 30 each generate the signature key for generating the digital signature and the verification key by the signature key pair generation unit 112, the signature key pair generation unit 212, and the signature key pair generation unit 311 in advance, respectively. It is further assumed that the manager device 10, the trusted hardware 20, and the participant device 30 exchange the verification keys generated by them in advance. Therefore, each of the signature verification key storage unit 123 of the manager device 10, the signature verification key storage unit 222 of the trusted hardware 20, and the signature verification key storage unit 321 of the participant device 30 stores a verification key of a digital signature of another device in the storage device.

It is desired that the trusted hardware 20 be trusted hardware and participants be able to verify the internal program thereof. Whether or not the trusted hardware 20 is trusted hardware can be verified, for example, by authentication by a manufacturer of the trusted hardware 20. Further, the program stored in the trusted hardware 20 may be verified if the trusted hardware 20 is able to attach the digital signature to the program itself or its hash value and output them when required to do so. Accordingly, the verifier can check whether the role of the disclosure manager is correctly implemented and the private key generated inside is not externally output.

### (Setup Operation)

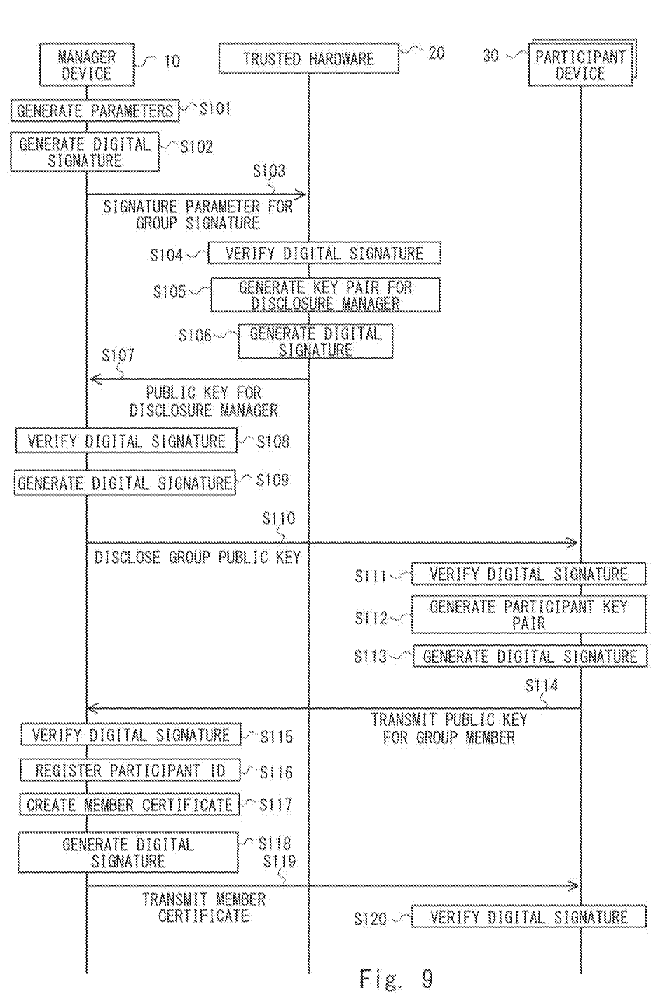

First, with reference to FIG. 9, a setup operation performed before the auction starts will be described,
(Step S101) The parameter setting unit 111 of the manager device 10 sets parameters that are necessary to create the group signature. The specific contents of the parameters are as follows.

n, e: public keys of a Divest-Shamir-Adleman (RSA) public key encryption scheme.

d: a private key of the auction manager.

The symbol n denotes a product of two prime numbers having predetermined number of bits determined by the security parameter, and the security parameter is, for example, the length of the key to be generated. Note that the manager device 10 uses the private key d of the auction manager to create the member certificate,
p: a prime number in which p-1 becomes a multiple of n.
g: a generator of a cyclic group G of an order n. The symbol G is a subgroup of
Zₚ*. The symbol Zₚ* is a reduced residue class group modulo p.
a: a element of Zₙ* whose order is ϕ(n)/4. The symbol ϕ denotes an Euler function.
λ: an upper limit of the length of the private key of the auction participant and a constant ε. The symbol ε is a parameter used to create the zero-knowledge proof data. The details thereof are disclosed in Non-Patent Literature 3.
(Step S102) The signature generation unit 113 of the manager device 10 grants the digital signature to a message including the parameters other than the private key of the auction manager generated in Step S101.
(Step S103) Then the information communication unit 131 of the manager device 10 transmits parameters other than the private key of the auction manager to the trusted hardware 20 as a signature parameter for the group signature.
(Step S104) The signature verification unit 214 of the trusted hardware 20 verifies the digital signature applied to the message received from the manager device 10 using the verification key stored by the signature verification key storage unit 222.
(Step S105) The parameter setting unit 215 of the trusted hardware 20 calculates the follows using the parameters received from the manager device 10.
ω: a random element (a random number) of Zₙ*. The symbol ω is used as the private key of the disclosure manager.
h: a random generator of G.
Y_{R}: Y_{R}=h^{ω}. The symbol Y_{R} is used as the public key of the disclosure manager.
b: an integer other than 1.
(Step S106) The signature generation unit 213 of the trusted hardware 20 attaches the digital signature to (h, b, Y_{R}).
(Step S107) Then the information communication unit 231 of the trusted hardware 20 transmits the message to which the digital signature has been applied in Step S106 to the manager device 10 as the public key for the disclosure manager.
(Step S108) The signature verification unit 114 of the manager device 10 verifies the digital signature of the message received from the trusted hardware 20.
(Step S 109) The signature generation unit 113 of the manager device 10 applies the digital signature to the public key Y=(n, e, G, g, a, b, λ, ε, h, Y_{R}) of the group.
(Step S110) The information communication unit 131 of the manager device 10 transmits the message created in Step S109 to the participant device 30.
(Step S111) The signature verification unit 313 of the participant device 30 verifies the digital signature of the message received from the manager device 10 using the signature verification key of the manager device 10 stored by the signature verification key storage unit 321.

### (Registration Operation)

Next, with reference to FIG. 9, a registration operation of the participant device 30 in the group will be described.
(Step S112) After Step S111, the parameter setting unit 314 of the participant device 30 calculates the follows based on the group public key, thereby generating a participant key pair (that is, the private key for the group member and the public key for the group member).
x: a random number smaller than 2^{λ}-1.
y: y=g^{x} mod n

Here, x denotes the private key for the group member and y denotes the public key for the group member.
(Step S113) The signature generation unit 312 of the participant device 30 applies the digital signature to the public key y for the group member generated in Step S112.
(Step S114) The information communication unit 331 of the participant device 30 transmits the public key y for the group member with the digital signature to the manager device 10.
(Step S115) The signature verification unit 114 of the manager device 10 verifies the digital signature included in the message received from the participant device 30 using the signature verification key stored by the signature verification key storage unit 123.
(Step S116) The data storage unit 121 of the manager device 10 stores the public key y for the group member and the ID of the participant device 30 as a pair. This data is used for identifying the participant device 30 in a later process.
(Step S117) The parameter setting unit 111 of the manager device 10 calculates the member certificate v by calculating the following Expression 1.

v=(y+b)d mod n (Expression 1)
(Step S 118) The signature generation unit 113 of the manager device 10 grants the digital signature to the member certificate generated in Step S117.
(Step S119) The information communication unit 131 of the manager device 10 transmits, to the participant device 30, the member certificate to which the digital signature has been attached.
(Step S120) The signature verification unit 313 of the participant device 30 verifies the digital signature of the message received from the manager device 10 using the signature verification key stored by the signature verification key storage unit 321.

According to the registration operation described above, the private key x for the participant and the member certificate v that are necessary to create the group signature have been obtained in the participant device 30.

### (Bidding Operation)

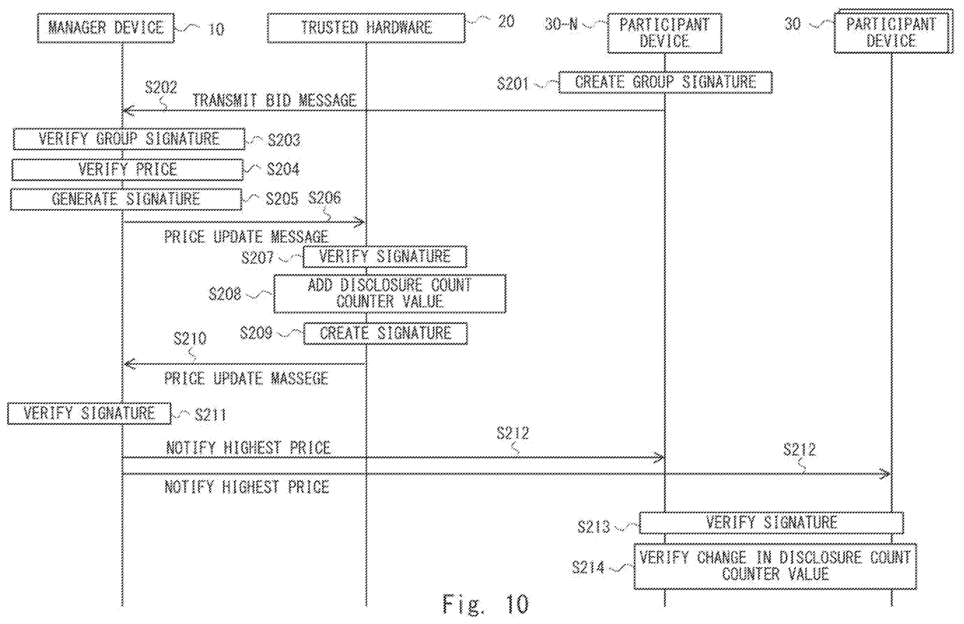

Next, with reference to FIG. 10, a schematic operation when the participant device 30 makes a bid will be described. In this example, a case in which the participant device 30-N of the participant devices 30 has made a bid will be described.
(Step S201) The signature generation unit 312 of the participant device 30-N generates the group signature (g′, z′, d₁, d₂, V₁, V₂, V₃) for the bid message in (i.e., bid) generated by the hid message generation unit 315 in the following procedures.

The signature generation unit 312 first performs the following calculations (Expressions 2-5).
r, u: random numbers in Zₙ*

g′=g^{r} (Expression 2)

z′=g′^{y} (Expression 3)

d₁=Y_{R}^{u} g^{y} (Expression 4)

d₂=h^{u} (Expression 5)

Next, the signature generation unit 312 creates three pieces of zero-knowledge proof data V₁, V₂, and V₃ indicated by the following Expressions (Expressions 6-8) using the results of the calculations in Expressions 2-5, the private key for the participant, the member certificate, and the bid message m.

V₁=SK{(γ, δ):z′=g′^{γ}A d₂=h^{δ}A d₁=Y_{R}^{δ}g^{γ}}(m) (Expression 6)

V₂=SK{(β):z′=g′\hat{ }(a\hat{ }β)}(V₁) (Expression 7)

V₃=SK{(α):z′g′^{b}=g′\hat{ }(α\hat{ }e)}(V₂) (Expression 8)

Now, symbols according to the zero-knowledge proof data will be described. Sk{:(x₁, . . . , xₖ):z₁=f₁(x₁, . . . , xₖ) \hat{ } . . . \hat{ } z₁=f₁(x₁, . . . , xₖ)}(m) indicates that data proving that secrets x₁, . . . , xₖ that satisfy expressions from z₁=f₁(x₁, . . . , xₖ) to z₁=f₁(x₁, . . . , xₖ) are known has been granted to the message m.

Since the details of the zero-knowledge proof are described in Non-Patent Literature 4, a method of creating the zero-knowledge proof data and a verification method will be described taking V₃ as an example. The actual zero-knowledge proof data V₃ is (V₂, c, s, g₀, . . . , gₑ) that satisfies the following Expression 9.

c=H(V₂∥g₀∥. . . ∥g₀∥g₀^{r}∥. . . ∥gₑ₋₁^{r}) (Expression 9)

The symbols and the variables shown in the above Expression are as follows.
∥: a concatenation operator
H: a hash function
r: a random number in Zₙ*
s=r-cα mod n
g₀'g′
gᵢ₊₁=gᵢ^{α}(i=0, e-1)

Note that the signature verification unit 114 of the manager device 10 verifies whether the following two Expressions (Expressions 10 and 11) are established using (V₂, c, s, g₀, . . . gₑ) and the public key Y of the group when the zero-knowledge proof data is verified.

z′g′^{b}=g_{c} (Expression 10)

c=H(V₂∥g₀∥. . . ∥gₑ∥g₀^{g} g₁^{c}∥. . . ∥gₑ₋₁^{g} gₑ^{c}) (Expression 11)

Next, operations after Step S201 will be described.
(Step S202) The information communication unit 331 of the participant device 30-N transmits the bid message with the group signature to the manager device 10.
(Step S203) The signature verification unit 114 of the manager device 10 verifies the group signature of the bid message received from the participant device 30-N.
(Step S204) The price verification unit 115 of the manager device 10 verifies whether or not the price indicated in the received bid message is a price that updates the current highest price by comparing it with the current highest price stored by the bid information storage unit 122.
(Step S205) When the bid updates the highest price, the price verification unit 115 of the manager device 10 creates a price update message (a message indicating the updated current highest price). Then the signature generation unit 113 grants the digital signature to the price update message.
(Step S206) The information communication unit 131 of the manager device 10 transmits the price update message to the trusted hardware 20. That is, the information communication unit 131 of the manager device 10 transmits, when the current evaluated value (i.e., evaluated value of the auction target) in the electronic auction is updated, the update information of the evaluated value (i.e., the evaluated value after the update) to the trusted hardware 20. While the evaluated value is a price as an example in this example embodiment, it is needless to say that another value that indicates the value of an auction item may be used as the evaluated value. Accordingly, the information communication unit 231 of the trusted hardware 20 receives the update information on a current evaluated value in the electronic auction.
(Step S207) The signature verification unit 214 of the trusted hardware 20 verifies the digital signature of the price update message using the verification key stored. by the signature verification key storage unit 222.
(Step S208) When the signature has been successfully verified, the disclosure count grant message generation unit 216 of the trusted hardware 20 creates a message in which the count value of the number of times of disclosure and the highest price are combined with each other.
(Step S209) The signature generation unit 213 of the trusted hardware 20 generates the digital signature for the message created in Step S208, that is, the price update message including the count value, and grants the generated digital signature to this message.
(Step S210) The information communication unit 231 of the trusted hardware 20 transmits the price update message to which the digital signature has been granted to the manager device 10. While the case in which the trusted hardware 20 and the participant device 30 are not communicably connected to each other is described in this example embodiment, the price update message may be directly transmitted from the trusted hardware 20 to the participant device 30 when the trusted hardware 20 and the participant device 30 are connected to each other. As described above, the information communication unit 231 of the trusted hardware 20 transmits information in which the price update message and the current number of times of disclosure that is stored (the number of times the group signature creator specifying information is generated) are associated with each other.
(Step S211) The signature verification unit 114 of the manager device 10 verifies the digital signature of the message received from the trusted hardware 20 using the signature verification key stored by the signature verification key storage unit 123.
(Step S212) The information communication unit 131 of the manager device 10 transmits the price update message including the count value of the number of times of disclosure to all the participant devices 30.
(Step S213) The signature verification unit 313 of the participant device 30 verifies the digital signature of the trusted hardware 20 granted to the message received from the manager device 10 using the signature verification key of the trusted hardware 20 stored by the signature verification key storage unit 321.
(Step S214) The count value verification unit 316 of the participant device 30 checks whether or not the count value of the number of times of disclosure included in the price update message received from the manager device 10 this time is the same as the count value of the number of times of disclosure included in the price update message received last time. When they are different from each other, this means that the bidder has been identified. Further, when they are different from each other, the count value verification unit 316 calculates the difference between the two count values, thereby being able to know the number of times the manager device 10 has identified the bidder information.

### (Identifying Operation)

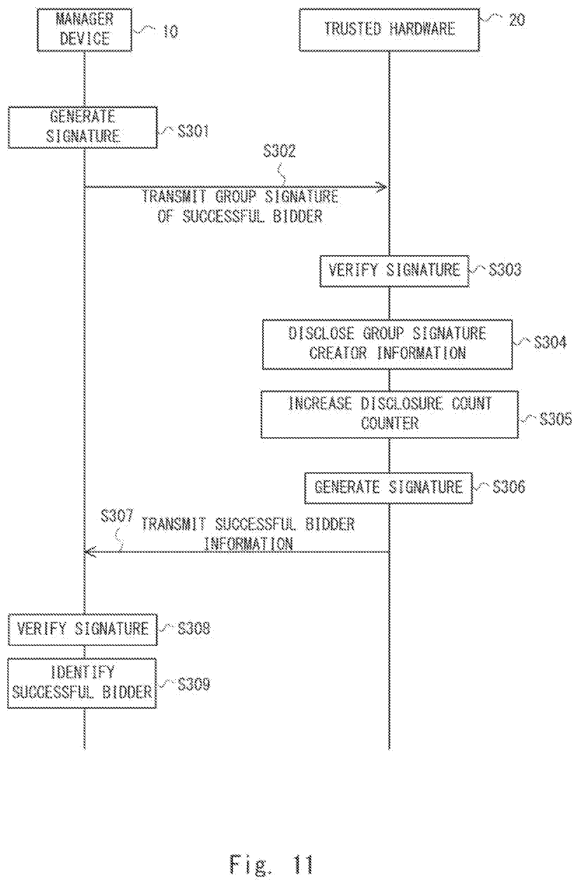

Next, with reference to FIG. 11, operations of the manager device 10 and the trusted hardware 20 when the manager device 10 identifies the participant device 30 that has created the bid message and the group signature included in the bid message will be described.
(Step S301) After the auction is finished, the signature generation unit 113 of the manager device 10 acquires (d₁, d₂) from the bid message in which the highest bid has been placed and that has been stored by the bid information storage unit 122, and grants the digital signature thereto.
(Step S302) The information communication unit 131 of the manager device 10 requests the trusted hardware 20 to disclose information for identifying the creator of the group signature by transmitting (d₁, d₂) with the above digital signature to the trusted hardware 20. That is, the information communication unit 131 transmits the group signature of the successful bidder to the trusted hardware 20, thereby requesting the trusted hardware 20 to disclose information for identifying the successful bidder. As described above, the information communication unit 131 transmits, to the trusted hardware 20, the anonymous electronic signature granted to the bid information regarding which the participant device that has transmitted the bid information should be identified among the bid information pieces that have been received by the manager device 10. Then the information communication unit 231 of the trusted hardware 20 receives the anonymous electronic signature from the manager device 10.
(Step S303) The signature verification unit 214 of the trusted hardware 20 verifies the digital signature of the message received from the manager device 10 using the verification key stored by the signature verification key storage unit 222.
(Step S304) The data disclosure unit 211 of the trusted hardware 20 calculates the group signature creator specifying information z using the held private key ω as shown in Expression 12.

z=d₁/d₂¹⁰⁷ =g⁷ (Expression 12)
(Step S305) The disclosure count storage unit 221 of the trusted hardware 20 stores a value obtained by increasing the count value that is currently stored by one as a new count value.
(Step S306) The signature generation unit 213 of the trusted hardware 20 grants the digital signature to the group signature creator specifying information z.
(Step S307) The information communication unit 231 of the trusted hardware 20 transmits the group signature creator specifying information z with the digital signature to the manager device 10 as successful bidder information. Accordingly, the information communication unit 131 of the manager device 10 receives the group signature creator specifying information z from the trusted hardware 20.
(Step S308) The signature verification unit 114 of the manager device 10 verifies the digital signature of the message received from the trusted hardware 20 using the signature verification key stored by the signature verification key storage unit 123,
(Step S309) After the manager device 10 receives the group signature creator specifying information z, the group signature creator confirmation unit 116 of the manager device 10 identifies the ID of the participant device 30 using the information stored by the data storage unit 121 and the group signature creator specifying information z.

The first example embodiment has been described above. In the auction system 11 according to the first example embodiment, the number of times the group signature creator specifying information z is generated (the number of times of disclosure) is recorded in the trusted hardware 20. It is therefore possible to manage the number of times the participant device that has created the group signature has been identified. Therefore, it is possible to prevent the member that has created the group signature from being arbitrarily identified. Further, as shown in Step S210 in FIG. 10, in the auction system 11, the trusted hardware 20 transmits information in which the price update message is associated with the current number of times of generation of the group signature creator specifying information z (the number of times of disclosure). Therefore, the participant device 30 is able to know the presence or the absence of unauthorized disclosure every time the price is updated in the auction. That is, the participant device 30 is able to know the count value of the trusted hardware 20 included in the price update message from the manager device 10, and therefore it becomes possible to detect whether the manager device 10 has identified the bidder in the middle of the bidding. Further, in Step S210 in FIG. 10, the information communication unit 231 of the trusted hardware 20 transmits the message to which the digital signature of the trusted hardware 20 has been applied. Therefore, it is possible to guarantee that the counter value received by the participant device 30 has been transmitted from the trusted hardware 20. Further, the trusted hardware 20 is guaranteed to include a mechanism for preventing leakage of data in advance. Therefore, a device other than the trusted hardware 20 cannot generate the group signature creator specifying information without updating the counter value based on the private key that has been fraudulently acquired from the trusted hardware 20.

### Second Example Embodiment

Next, a second example embodiment will be described. In the first example embodiment, the participant device 30 is able to detect whether the manager device 10 has identified the bidder in the middle of the bidding by knowing the count value of the number of times of disclosure included in the price update message. However, when the auction manager (the manager device 10) has asked the trusted hardware 20 to disclose the group signature creator specifying information after the bidding is ended, it is possible that the bidder may be identified without being known to participants (the participant devices 30). In order to avoid this state, in the second example embodiment, a trusted hardware 40 including a function of setting an upper-limit value on the number of times of disclosure is used in place of the trusted hardware 20. Like in the first example embodiment, in this example embodiment as well, the manager device 10 and the participant device 30 are used for the auction system. Hereinafter, regarding configurations and operations similar to those in the first example embodiment, the overlapping descriptions will be omitted as appropriate.

The trusted hardware 40 is different from the trusted hardware 20 in that the storage unit 220 is replaced by a storage unit 420. The storage unit 420 is different from the storage unit 220 in that the storage unit 420 includes a disclosure count upper-limit value storage unit 423.

The disclosure count upper-limit value storage unit 423 stores the upper limit of the number of times of disclosure of the group signature creator specifying information, that is, the upper limit of the number of times the group signature creator specifying information is generated in a storage device such as the memory 151. The upper-limit value to be stored is set in a setup stage. In the setup stage, this upper-limit value is sent to the participant device 30. Accordingly, the auction participants are able to know the number of times the auction manager can identify the bidder. For the sake of simplification, in this example embodiment, the upper-limit value to be stored is set to 1. However, the upper-limit value is not limited to 1 and may be any number as long as the agreement can be made between the auction manager and the participant. This upper-limit value may be the maximum number of successful bidders in an electronic auction. By setting the maximum number of successful bidders as the upper-limit value, the bidders other than the successful bidder can be prevented from being fraudulently identified.

In this example embodiment, the data disclosure unit 211 newly generates the group signature creator specifying information when the number of times of disclosure of the group signature creator specifying information (number of times of generation) is smaller than a predetermined upper-limit value. Therefore, when the trusted hardware 40 receives the request to disclose the group signature creator specifying information from the manager device 10 in the bidder identifying operation, the data disclosure unit 211 operates as follows. That is, the data disclosure unit 211 calculates the group signature creator specifying information using the private key ω for the disclosure manager only when the count value for the number of times of disclosure of the group signature creator specifying information is smaller than the upper-limit value stored by the disclosure count upper-limit value storage unit 423.

### (Description of Operations)

Hereinafter, operations of the auction system according to the second example embodiment will be described.

### (Setup Operation)

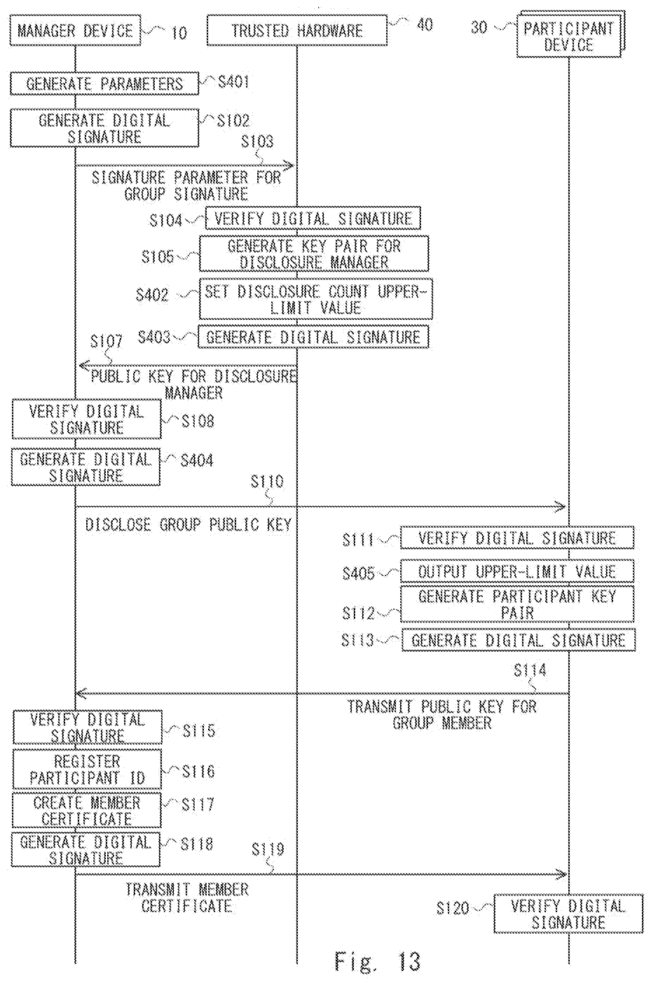

With reference to FIG. 13, a setup operation in the English auction system according to the second example embodiment will be described. In the following description, the description of the steps similar to the steps shown in FIG. 9 will be omitted. The omitted parts of the description regarding FIG. 13 will be complemented by replacing the trusted hardware 20 in the description with regard to FIG. 9 by a trusted hardware 40.

The sequence diagram shown in FIG. 13 is different from the sequence diagram shown in FIG. 9 in the following points.

Step S101 is replaced by Step S401.

Step S106 is replaced by Steps S402 and S403.

Step S109 is replaced by Step S404.

Step S405 is added between Step S111 and Step S112.

Hereinafter, a sequence diagram shown in FIG. 13 will be described.
(Step S401) The parameter setting unit 111 of the manager device 10 further sets, besides the parameters generated in Step S101 in FIG. 9, a disclosure count upper-limit value L.

After Step S401, the processing moves to Step S102. Further, after Steps S102-S105, the processing moves to Step S402.
(Step S402) The disclosure count upper-limit value storage unit 423 of the trusted hardware 40 stores the disclosure count upper-limit value L set by the manager device 10 in the storage device. Accordingly, the disclosure count upper-limit value L is set in the trusted hardware 40.
(Step S403) The signature generation unit 213 of the trusted hardware 40 attaches the digital signature to (L, h, b, Y_{R}). After Step S403, the processing moves to Step S107. Further, after Steps S107 and S108, the processing moves to Step S404.
(Step S404) The signature generation unit 113 of the manager device 10 grants the digital signature to the public key of the group Y=(n, e, G, g, a, b, λ, ε, h, Y_{R}) and the message received from the trusted hardware 40 in Step S107. After Step S404, processing of Steps S110 and S111 is performed. After Step S111, the processing moves to Step S405.

### (Registration Operation)

Next, a registration operation of the participant device 30 in a group will be described.
(Step S405) The information communication unit 331 of the participant device 30 outputs the disclosure count upper-limit value L received from the manager device 10 to a device that the participant can recognize. This output may either be display output by display or voice output for reading out the disclosure count upper-limit value L by voice. After Step S405, the processing moves to Step S112. After that, processing of Steps S112-S120 is performed.

### (Bidding Operation)

Since the processing in the bidding operation is performed in a flow similar to that in FIG. 10 referred to in the description of the first example embodiment, the description of this processing will be omitted.

### (Identifying Operation)

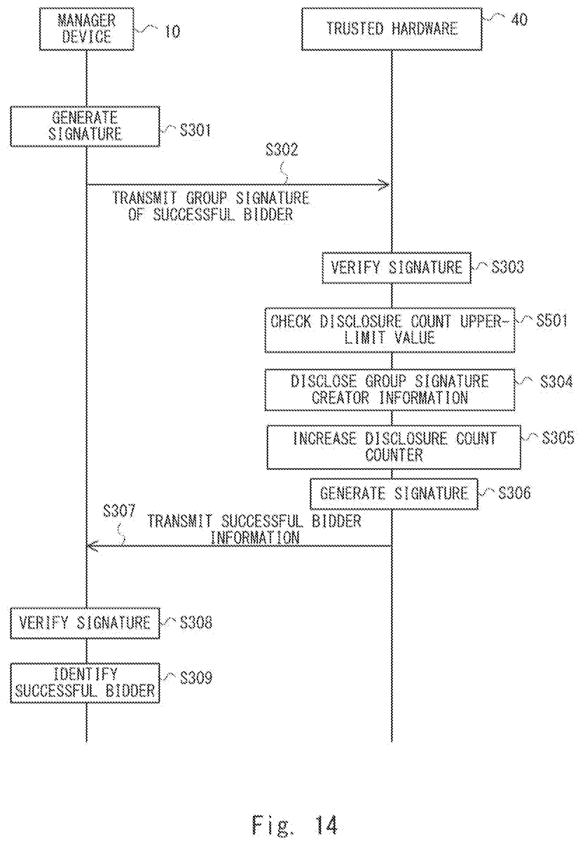

Next, with reference to FIG. 14, an operation of identifying the participant device 30 that has created the group signature in the auction system according to the second example embodiment will be described. In the following description, descriptions of steps that are similar to the steps shown in FIG. 11 will be omitted.

The sequence diagram shown in FIG. 14 is different from the sequence diagram shown in FIG. 11 in that Step S501 is added between Step S303 and Step S304.

After Steps S301-S303, the processing proceeds to Step S501.
(Step S501) A data disclosure unit 411 of the trusted hardware 40 confirms that the current count value of the number of times of disclosure stored by the disclosure count storage unit 421 is smaller than the upper-limit value stored by the disclosure count upper-limit value storage unit 423. When the count value of the number of times of disclosure is equal to or larger than the disclosure count upper-limit value, the data disclosure unit 411 of the trusted hardware 40 executes predetermined exception processing. The exception processing indicates, for example, outputting an error message or an alert message. When the count value of the number of times of disclosure is smaller than the disclosure count upper-limit value, the processing of Steps S304-S309 is performed.

The second example embodiment has been described above, in the second example embodiment, when the number of times the group signature creator specifying information is generated (the number of times of disclosure) is smaller than a predetermined upper-limit value, the data disclosure unit 211 newly generates group signature creator specifying information. Accordingly, the number of times the manager device 10 can identify the bidder information can be limited. Accordingly, for example, it is possible to prevent the administrator from unlimitedly identifying bidders after the auction ends.

### Third Example Embodiment

Next, a third example embodiment will be described. In the second example embodiment, the participant device 30 acquires the price update message only from the manager device 10. In this case, the manager device 10 may arbitrarily send different price update messages to the respective participant devices 30. It is also required to prevent the manager device 10 from intentionally ignoring bid messages or fraudulently manipulating the price by a price update message including a fake highest bid. In the following description, the third example embodiment that achieves this object will be described. In the following description, regarding configurations and operations similar to those stated in the aforementioned example embodiments, the overlapping description will be omitted as appropriate.

### (Outline of System Configuration)

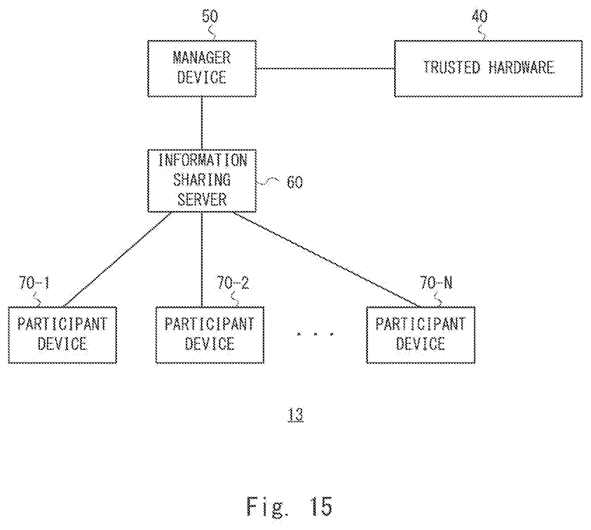

The third example embodiment will be described. FIG. 15 is a diagram showing one example of a configuration of the auction system 13 according to the third example embodiment. As shown in FIG. 15, the auction system 13 is configured to include a manager device 50, a trusted hardware 40, an information sharing server 60, and participant devices 70-1 to 70-N (N is an integer, the same is applied below). In the following description, when it is not particularly necessary to differentiate the participant devices 70-1 to 70-N, each of them is simply referred to as a “participant device 70”. The manager device 50 and the trusted hardware 40 are connected to each other in such a way that they can communicate with each other. Further, the information sharing server 60 is connected to the manager device 50 and the participant device 70 via a network such as the Internet in such a way that they communicate with each other.

### (Manager Device 50)

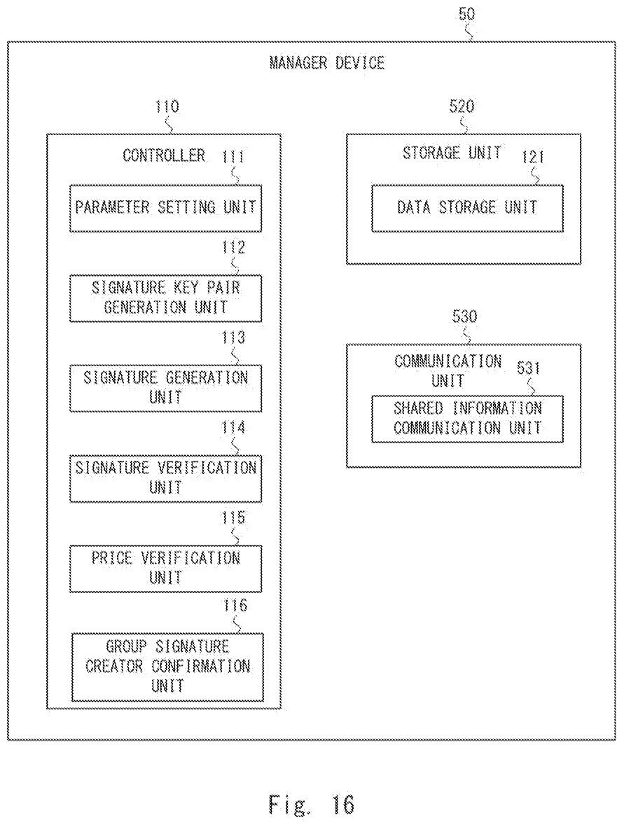

FIG. 16 is a block diagram showing one example of a configuration of the manager device 50. As shown in FIG. 16, the manager device 50 includes a controller 110, a storage unit 520, and a communication unit 530. That is, the manager device 50 is different from the manager device 10 in that the storage unit 120 is replaced by a storage unit 520 and the communication unit 130 is replaced by a communication unit 530. Further, the storage unit 520 is different from the storage unit 120 of the manager device 10 in that it includes only the data storage unit. The communication unit 530 includes a shared information communication unit 531. The shared information communication unit 531 performs communication with the trusted hardware 40 and the information sharing server 60 using the network interface 150.

### (Information Sharing Server 60)

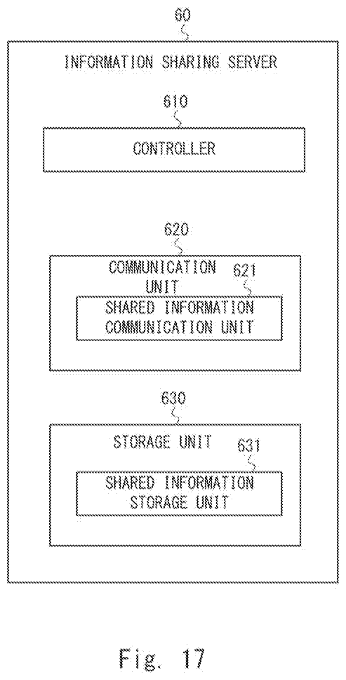

The information sharing server 60 is a device for sharing the bid information and the signature verification key between the manager device 50 and the participant device 70. FIG. 17 is a block diagram showing one example of a configuration of the information sharing server 60. As shown in FIG. 17, the information sharing server 60 includes a controller 610, a communication unit 620, and a storage unit 630. Each of the components shown in FIG. 17 is achieved by the information sharing server 60 serving as a computer executing a program. That is, the information sharing server 60 includes, for example, a configuration shown in FIG. 6. Therefore, for example, the processor 152 of the information sharing server 60 loads software (computer program) from the memory 151 of the information sharing server 60 and executes the loaded software (computer), thereby performing processing of each component shown in FIG. 17.

The controller 610 controls each part of the information sharing server 60. The storage unit 630 includes a shared information storage unit 631. The shared information storage unit 631 stores the bid information, and the signature verification key of the manager device 50, the trusted hardware 40, and the participant device 70 in a storage device such as the memory 151. The communication unit 620 includes a shared information communication unit 621. The shared information communication unit 621 performs communication with the manager device 50 and the participant device 70 using the network interface 150. It is assumed that the information that is necessary to perform communication (e.g., Internet Protocol Address (IP address)) is registered in the shared information communication unit 621 in advance.

### (Participant Device 70)

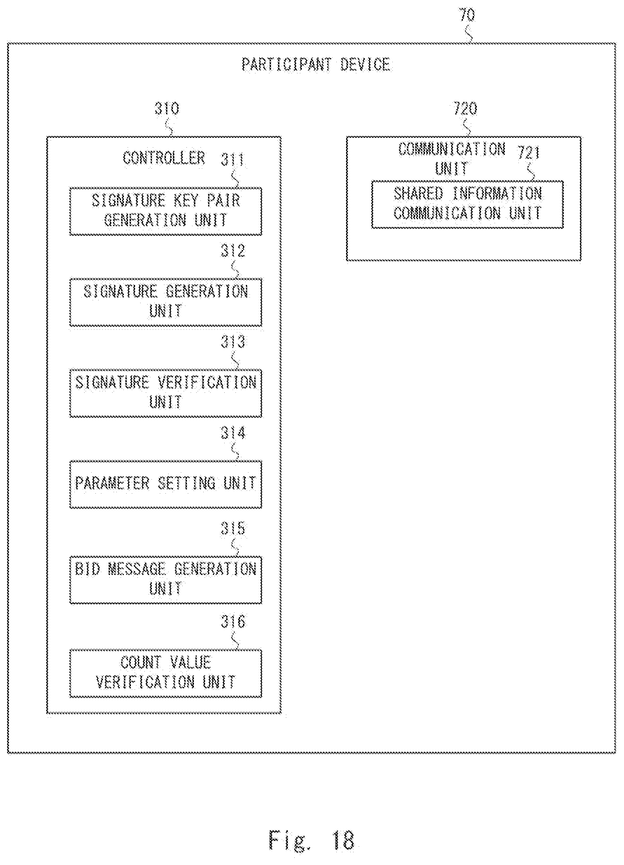

FIG. 18 is a block diagram showing one example of a configuration of the participant device 70. As shown in FIG. 18, the participant device 70 includes a controller 310 and a communication unit 720. That is, the participant device 70 is different from the participant device 30 in that the storage unit 320 is omitted and the communication unit 330 is replaced by a communication unit 720. The reason why the storage unit 320 is omitted is that the information stored in the participant device 30 by the storage unit 320 is stored in the information sharing server 60 in this example embodiment. The communication unit 720 includes a shared information communication unit 721. The shared information communication unit 721 performs communication with the information sharing server 60 using the network interface 150.

### (Description of Operations)

Hereinafter, operations of the auction system according to the third example embodiment will be described,

### (Setup Operation)

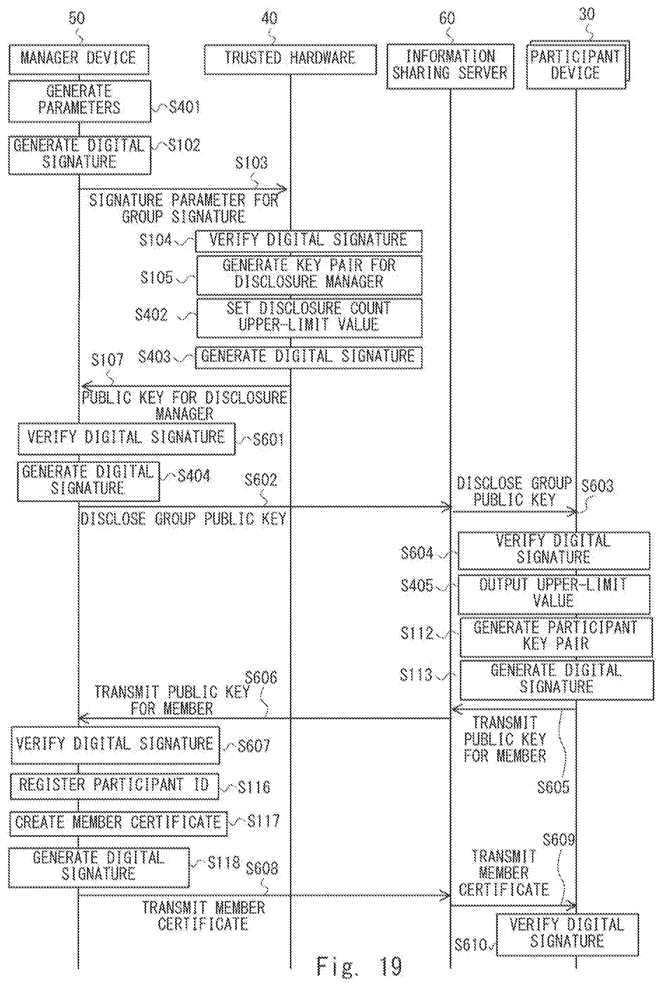

With reference to FIG. 19, a setup operation in the English auction system according to the third example embodiment will be described. In the following description, descriptions of steps that are similar to the steps shown in FIG. 13 described in the second example embodiment will be omitted.

The sequence diagram shown in FIG. 19 is different from the sequence diagram shown in FIG. 13 in that the verification key for verifying the signature is acquired from the information sharing server 60 and the transmission/reception of the group public key, the public key for the group member, and the member certificate are performed via the information sharing server 60. To be more specific, the sequence diagram shown in FIG. 19 is different from the sequence diagram shown in FIG. 13 in the following points.

Step S108 is replaced by Step S601.

Step S110 is replaced by Steps S602 and S603.

Step S111 is replaced by Step S604.

Step S114 is replaced by Steps S605 and S606.

Step S115 is replaced by Step S607.

Step S119 is replaced by Steps S608 and S609.

Step S120 is replaced by Step S610.

Hereinafter, the sequence diagram shown in FIG. 19 will be described.

After Steps S401-S107, the processing moves to Step S601.
(Step S601) The shared information communication unit 531 of the manager device 50 acquires the signature verification key of the trusted hardware 40 stored by the shared information storage unit 631 of the information sharing server 60. Then the signature verification unit 114 verifies the digital signature of the message received from the trusted hardware 40 using the acquired signature verification key. Ii should be noted that this is merely one example and the manager device 50 may own the signature verification key. After Step S601, the processing moves to Step S404 and then to Step S602.
(Step S602) The shared information communication unit 531 of the manager device 50 transmits the group public key (the message obtained in Step S404) to the information sharing server 60. The shared information storage unit 631 of the information sharing server 60 stores the received group public key in the storage device of the information sharing server 60.
(Step S603) The shared information communication unit 621 of the information sharing server 60 transmits the group public key received from the manager device 50 to the participant device 70. It should be noted that this is merely one example and the participant device 70 may regularly inquire the information sharing server 60 about newly-arrived information. Further, the group public key may be directly transmitted to each of the participant devices 70 without using the information sharing server 60. After Step S603, the processing moves to Step S604.
(Step S604) The shared information communication unit 721 of the participant device 70 acquires the signature verification key of the manager device 50 from the information sharing server 60. Then the signature verification unit 313 verifies the digital signature of the manager device 50 using the signature verification key. It should be noted that this is merely one example and the participant device 70 may own the signature verification key. After Step S604, the processing moves to Step S405. Then after Steps S405, S112, and S113, the processing moves to Step S605.
(Step S605) The shared information communication unit 721 of the participant device 70 transmits the public key for the participant to the information sharing server 60. The shared information storage unit 631 of the information sharing server 60 stores the received public key for the participant in the storage device of the information sharing server 60.
(Step S606) The shared information communication unit 621 of the information sharing server 60 transmits the public key for the participant to the manager device 50. It should be noted that this is merely one example and the manager device 50 may regularly inquire the information sharing server 60 about newly-arrived information. After Step S606, the processing moves to Step S607.
(Step S607) The shared information communication unit 531 of the manager device 50 acquires the signature verification key of the participant device 70 stored by the shared information storage unit 631 of the information sharing server 60. Then the signature verification unit 114 verifies the digital signature of the message received from the participant device 30 via the information sharing server 60. After Step S607, the processing moves to Step S116. Then after Steps S116-S118, the processing moves to Step S608.
(Step S608) The shared information communication unit 531 of the manager device 50 transmits the member certificate to the information sharing server 60. Then the shared information storage unit 631 of the information sharing server 60 stores the received member certificate in the storage device. While the IDs are stored in the management device 50 by the data storage unit 121 of the manager device 50 in this example embodiment, the IDs may instead be stored in the information sharing server 60. In this case, in Step S603, the member certificate and the ID are transmitted and the shared information storage unit 631 of the information sharing server 60 stores the received pair of the member certificate and the ID in the storage device.
(Step S609) The shared information communication unit 621 of the information sharing server 60 transmits the member certificate received from the manager device 50 to the participant device 70. After Step S609, the processing moves to Step S610.
(Step S610) The shared information communication unit 721 of the participant device 70 acquires the signature verification key of the manager device 50 from the information sharing server 60. Then the signature verification unit 313 verifies the digital signature of the manager device 50 using the signature verification key.

### (Bidding Operation)

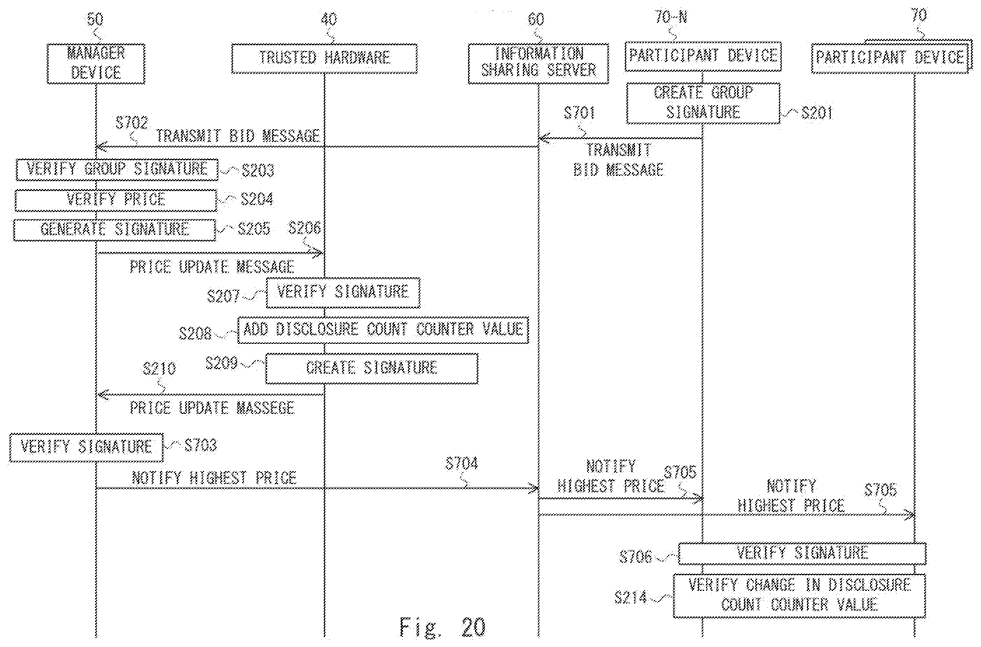

With reference to FIG. 20, a bidding operation in the English auction system according to the third example embodiment will be described. In the following description, descriptions of steps that are similar to the steps shown in FIG. 10 will be omitted.

The bidding operation according to this example embodiment is mainly different from the bidding operation according to the second example embodiment in the following points. The participant device 70 transmits the bid message to the information sharing server 60. Then the information sharing server 60 transmits the message to the manager device 50. Further, when the manager device 50 updates the highest bid, the manager device 50 transmits the price update message with the digital signature of the manager device 50 to the information sharing server 60. Then the information sharing server 60 transmits the message to the participant device 70. The participant device 70 verifies the digital signature included in the received message using the signature verification key acquired from the information sharing server 60.

Specifically, the sequence diagram shown in FIG. 20 is different from the sequence diagram shown in FIG. 10 in the following points.

Step S202 is replaced by Steps S701 and S702.

Step S211 is replaced by Step S703.

Step S212 is replaced by Steps S704 and S705.

Step S213 is replaced by Step S706.

Hereinafter, the sequence diagram shown in FIG. 20 will be described. After Step S201, the processing moves to Steps S701 and S702.
(Step S701) The shared information communication unit 721 of the participant device 70-N transmits the hid message with the group signature to the information sharing server 60. The shared information storage unit 631 of the information sharing server 60 stores the received bid message in the storage device of the information sharing server 60.
(Step S702) The shared information communication unit 621 of the information sharing server 60 transmits the bid message received from the participant device 70-N to the manager device 50. After Step S702, the processing moves to Step S203. After Steps S203-S210, the processing moves to Step S703.
(Step S703) The shared information communication unit 531 of the manager device 50 acquires the signature verification key of the trusted hardware 40 stored by the shared information storage unit 631 of the information sharing server 60. Then the signature verification unit 114 verifies the digital signature of the message received from the trusted hardware 40 using the acquired signature verification key. After Step S703, the processing moves to Steps S704 and S705.
(Step S704) The shared information communication unit 531 of the manager device 50 transmits the price update message including the count value of the number of times of disclosure to the information sharing server 60. The shared information storage unit 631 of the information sharing server 60 stores the received price update message in the storage device of the information sharing server 60.
(Step S705) The shared information communication unit 621 of the information sharing server 60 transmits the price update message received from the manager device 50 to all the participant devices 70. After Step S705, the processing moves to Step S706.
(Step S706) The shared information communication unit 721 of the participant device 70 acquires the signature verification key of the trusted hardware 40 from the information sharing server 60. Then the signature verification unit 313 verifies the digital signature of the trusted hardware 40 using the signature verification key. After Step S706, processing of Step S214 is performed.

As described above, since the bid message and the price update message are sent via the information sharing server 60, all the participant devices 70 are able to receive the same information at the same timing. Accordingly, it is possible to prevent the administrator from delaying a notification to be sent to a specific participant device 70 or ignoring a bid message intentionally or by mistake.

### (Identifying Operation)

An operation of identifying the participant device 70 that has created the group signature in the auction system 13 according to the third example embodiment is substantially the same as the operation of identifying the participant device 30 that has created the group signature in the auction system according to the second example embodiment. That is, the sequence of the identifying operation in this example embodiment is substantially the same as the sequence shown in FIG. 14. The difference between them is that when the manager device 50 verifies the digital signature of the trusted hardware 40, the verification key is acquired from the information sharing server 60 in this example embodiment. That is, in Step S308 in FIG. 14, in this example embodiment, the shared information communication unit 531 acquires the verification key stored in the information sharing server 60 and the signature verification unit 114 verifies the digital signature using the acquired signature verification key. As a matter of course, like in the second example embodiment, each device may store the verification key without causing the information sharing server 60 to store these verification keys.

The third example embodiment has been described above. In this example embodiment, the information sharing server 60 is installed and the bid message of the participant device 70 and the price update message of the manager device 50 are disclosed in the information sharing server 60. That is, the bid message (bid information) and the price update message (update information) are shared by the manager device 50 and the participant device 70. Therefore, all the participants are able to know the latest bid status. It is therefore possible to prevent the administrator from ignoring bid messages intentionally or by mistake, or fraudulently manipulating a price by sending the price update message to a specific participant at a timing earlier than the timing when it is sent to the other participants so that the specific participant is given an advantage.

As a modified example of this example embodiment, the signature verification unit 313 of the participant device 70 may have a function of verifying group signature data granted to the bid message shared by the information sharing server 60. With the group public key, anyone can verify the group signature data, whereby the signature verification unit 313 of the participant device 70 may verify the group signature using a group public key shared in the information sharing server 60, like the signature verification unit 114 of the manager device 50. In this case, the group public key may be shared in the information sharing server 60 or may be stored in the participant device 70 in advance. As described above, the participants verify the hid message created by another participant, whereby, if the administrator ignores a legitimate bid message and does not transmit a price update message, the participants are able to detect this situation. Further, if the administrator ignores an unauthorized bid message, the participants are able to know this situation.

### Fourth Example Embodiment

As described above, in the third example embodiment, it is possible to prevent fraud by the administrator by introducing the information sharing server 60 and sharing, by the manager device 50 and the participant device 70, the bid information. It is possible, however, that the bid information stored in the information sharing server 60 may be fraudulently tampered with and the correct bidding history may not remain. Therefore, in the fourth example embodiment, a blockchain is used as information sharing means.

In the blockchain, peer-to-peer (P2P) network and public key cryptography are used, and a distributed ledger is achieved by the blockchain. Each of all the participants in the blockchain own a pair of a public key and a private key, and an electronic signature by the private key, and the public key for the verification thereof are granted to all the pieces of information that have been generated to be entered in the ledger. Then this information is transmitted to all the participants of the blockchain via the P2P network, the electronic signature is verified, and then the information is entered in the ledger. The main features of the blockchain in are transparency and tampering resistance of the ledger (shared information). The transparency here indicates that it is guaranteed that all the participants in the blockchain can acquire the same information. The tampering resistance here indicates that it is difficult to temper with the data recorded in the ledger. The tampering resistance is obtained by the use of a hash chain.

In this example embodiment, the shared information such as the bid message or the price update message is entered in the ledger of the blockchain, not in the information sharing server, whereby it is possible to ensure transparency and tampering resistance of these pieces of information and prevent fraud by the administrator and changes in the bidding history described above.

### (Outline of System Configuration)

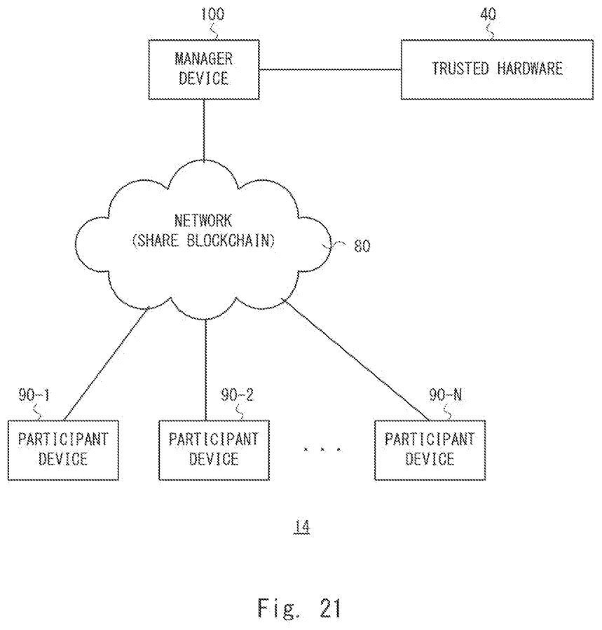

The fourth example embodiment will be described, FIG. 21 is a diagram showing one example of a configuration of an auction system 14 according to the fourth example embodiment. As shown in FIG. 21, the auction system 14 is configured to include a manager device 100, a trusted hardware 40, and participant devices 90-1 to 90-N (N is an integer, the same is applied below). In the following description, when it not particularly necessary to differentiate the participant devices 90-1 to 90-N, each of them is simply referred to as a “participant device 90”. The manager device 100 and the participant device 90 are connected to each other via a network 80 in such a way that they can communicate with each other and the trusted hardware 40 is connected to the manager device 100 in such a way that they can communicate with each other. The network 80 is a network such as the Internet, LAN, or VPN in which information communication can be performed.

### (Manager Device 100)

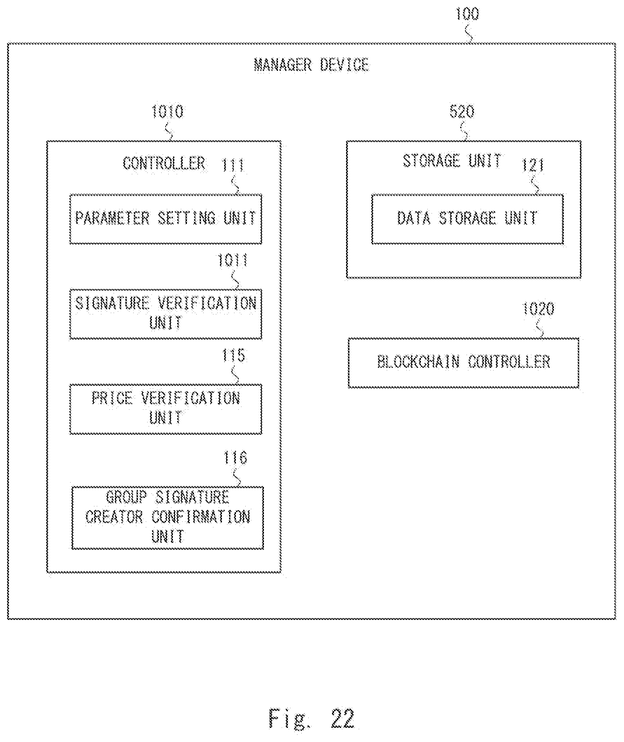

FIG. 22 is a block diagram showing one example of a configuration of the manager device 100. The manager device 100 includes a controller 1010, a storage unit 520, and a blockchain controller 1020. That is, the manager device 100 is different from the manager device 50 according to the third example embodiment in that the controller 110 is replaced by a controller 1010 and the communication unit 530 is replaced by a blockchain controller 1020.

The controller 1010 includes a parameter setting unit 111, a signature verification unit 1011, a price verification unit 115, and a group signature creator confirmation unit 116. That is, the controller 1010 is different from the controller 110 of the manager device 50 in that the signature key pair generation unit 112 and the signature generation unit 113 are omitted and the signature verification unit 114 is replaced by a signature verification unit 1011.

The signature verification unit 1011 verifies the group signature data granted to the bid message received via the network 80. Note that the verification method is similar to that in the aforementioned embodiments. The blockchain controller 1020 controls all the operations that relate to a distributed ledger. These operations include creation of the message with the electronic signature, verification of the electronic signature, update and storage of the ledger, transmission/reception of the message and the like via the P2P network. Further, the blockchain controller 1020 further performs, besides control of the blockchain, transmission/reception of the message between the manager device 100 and the trusted hardware 40. At this time, the blockchain controller 1020 grants the electronic signature to the message to be sent to the trusted hardware 40 and transmits the obtained message. The blockchain controller 1020 verifies the electronic signature granted to the message received from the trusted hardware 40. As described above, the blockchain controller 1020 uses techniques of grant and verification of the electronic signature used for the blockchain also for the communication with the trusted hardware 40 as well.

### (Participant Device 90)

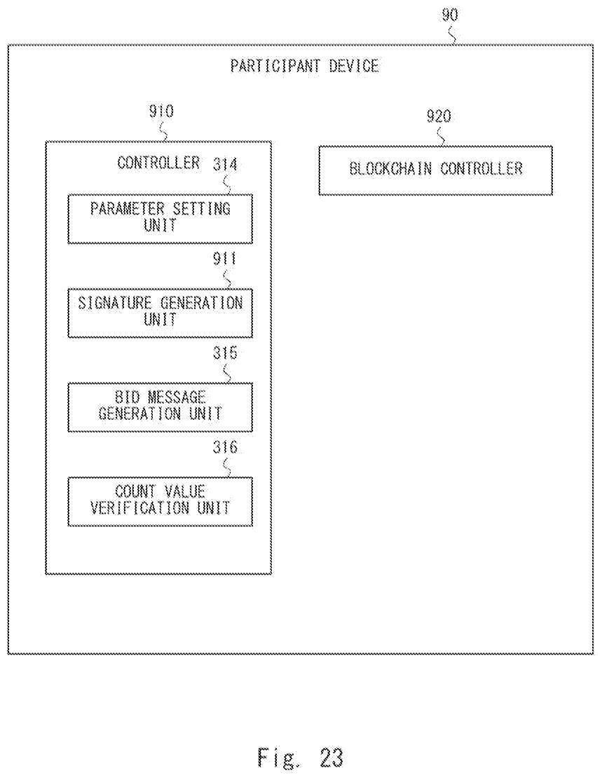

FIG. 23 is a block diagram showing one example of a configuration of the participant device 90. The participant device 90 includes a controller 910 and a blockchain controller 920. That is, the participant device 90 is different from the participant device 70 according to the third example embodiment in that the controller 310 is replaced by a controller 910 and the communication unit 720 is replaced by a blockchain controller 920.

The controller 910 includes a parameter setting unit 314, a signature generation unit 911, a bid message generation unit 315, and a count value verification unit 316. That is, the controller 910 is different from the controller 310 of the participant device 70 in that the signature key pair generation unit 311 and the signature verification unit 313 are omitted and the signature generation unit 312 is replaced by the signature generation unit 911. The signature generation unit 911 performs generation of the group signature. The generation method is similar to that in the signature generation unit 312 of the participant device 70. The blockchain controller 920 controls the messages other than the bid message in a way similar to the control performed in the blockchain controller 1020. Since the bid message granted to the group signature needs to be anonymous, the blockchain controller 920 does not grant the electronic signature.

### (Description of Operations)

Since the setting and the operation related to the blockchain are the same as those in a normal blockchain, the description thereof will be omitted in order to keep the explanation simple and only operations different from those of the normal blockchain will be described. The normal blockchain here assumes, for example, Hyperledger fabric. While a permissioned blockchain is suitable for convenience of use case, a permissionless blockchain may instead be performed since participants that can create the legitimate group signature are registered in advance. The operations different from those of the normal blockchain indicate, for example, a bid message. Unlike the message in the normal blockchain, the electronic signature of the creator is not granted. Since it is sufficient that the group signature be verified in this example embodiment, the bid message is regarded to be an effective message.

### (Setup Operation)

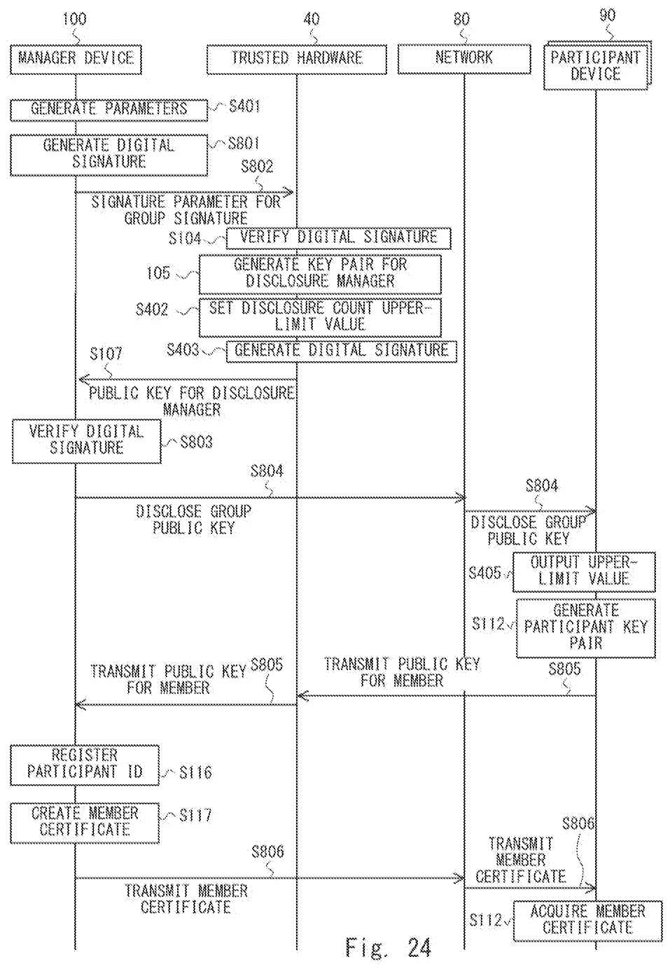

With reference to FIG. 24, a setup operation in the English auction system according to the fourth example embodiment will be described. In the following description, the detailed descriptions of the steps already described above will be omitted. While the communication processing, and the signature generation processing and the signature verification processing in the setup operation according to the fourth example embodiment are different from those in the third example embodiment since the blockchain is used in the fourth example embodiment, the basic processing flow is the same as that in the third example embodiment.

First, after the processing in Step S401 is performed in the manager device 100, the processing in Step S801 is performed.
(Step S801) The blockchain controller 1020 of the manager device 100 grants the digital signature to a message including parameters other than the private key of the auction manager generated in Step S401.
(Step S802) The blockchain controller 1020 of the manager device 100 transmits the message to which the digital signature has been applied to the trusted hardware 40.

After Step S802, the processing of Steps S104, S105, S402, S403, and S107 is performed.
(Step S803) The blockchain controller 1020 of the manager device 100 verifies the digital signature of the message received by the transmission in Step S107.
(Step S804) The blockchain controller 1020 of the manager device 100 performs processing of recording the public key of the group and the upper-limit value of the number of times of disclosure in the ledger. That is, the blockchain controller 1020 transmits the contents of the update to the participant device 90 via the network 80. On the other hand, the blockchain controller 920 of the participant device 90 verifies the signature of the message. When there is no problem, the public key of the group and the upper-limit value of the number of times of disclosure are recorded in the ledger.

After Step S804, processing of Steps S405 and S112 is performed. After Step S112, processing of Step S805 is performed.
(Step S805) The blockchain controller 920 of the participant device 90 records the public key for the group member in the ledger.

After Step S805, processing of Steps S116 and S117 is performed. After Step S117, processing of Step S806 is performed.
(Step S806) The blockchain controller 1020 of the manager device 100 records the member certificate in the ledger. In Step S806, the member certificate and the ID may be recorded in the ledger in such a way that they are associated with each other. It is assumed that the ID is associated with the member certificate so that the corresponding participant can be known. As another method, the public key of the participant device 90 may be recorded in the ledger in place of the ID.
(Step S807) After the recording processing in the ledger by the manager device 100 is performed, the blockchain controller 920 of the participant device 90 acquires the member certificate from the ledger.

### (Bidding Operation)

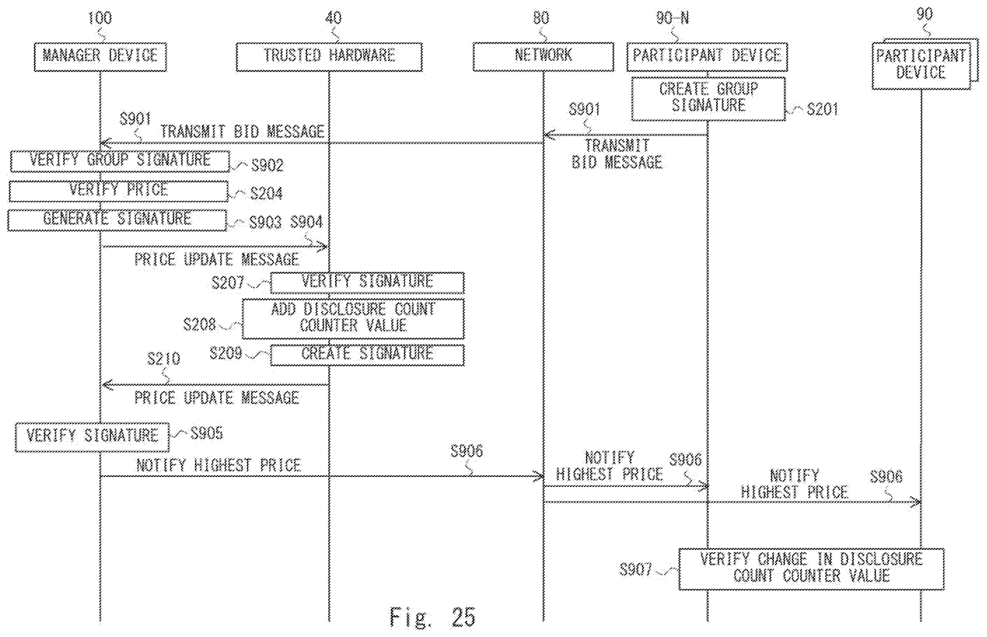

With reference to FIG. 25, a bidding operation in the English auction system according to the fourth example embodiment will be described. In the following description, the detailed descriptions of the steps already described above will be omitted. While the communication processing of the bidding operation in the fourth example embodiment is different from that in the third example embodiment since the blockchain is used in the fourth example embodiment, the basic processing flow is similar to that in the third example embodiment.

First, after the processing of Step S201 is performed in the participant device 90-N, processing of Step S901 is performed.
(Step S901) The blockchain controller 920 of the participant device 90 records the bid message with the group signature in the ledger.
(Step S902) The blockchain controller 1020 of the manager device 100 acquires the bid message and verifies the group signature granted to the bid message.

After Step S902, the processing of Step S204 is performed. After Step S204, the processing moves to Step S903.
(Step S903) The price verification unit 115 of the manager device 100 creates the price update message and the blockchain controller 1020 grants the digital signature to the price update message.
(Step S904) The blockchain controller 1020 of the manager device 100 transmits the price update message to the trusted hardware 40.

After Step S904, processing of Steps S207, S208, S209, and S210 is performed. After Step S210, processing of Step S905 is performed.
(Step S905) The blockchain controller 1020 of the manager device 100 verifies the digital signature of the message transmitted in Step S21.
(Step S906) The blockchain controller 1020 of the manager device 100 records the price update message in the ledger.
(Step S907) The blockchain controller 920 of the participant device 90 acquires the price update message and the count value verification unit 316 verifies whether the count value of the number of times of disclosure is a proper value,

Since the tampering resistance of shared information of the auction system has been improved by using the blockchain, the trusted hardware 40 may not include the count value of the number of times of disclosure in the message every time the bidding is performed. That is, Step S208 may not be performed every time the bidding is performed. In this case, the count value may be attached to the message only when the count value of the number of times of disclosure is changed and the obtained message may be recorded in the blockchain.

### (Identifying Operation)

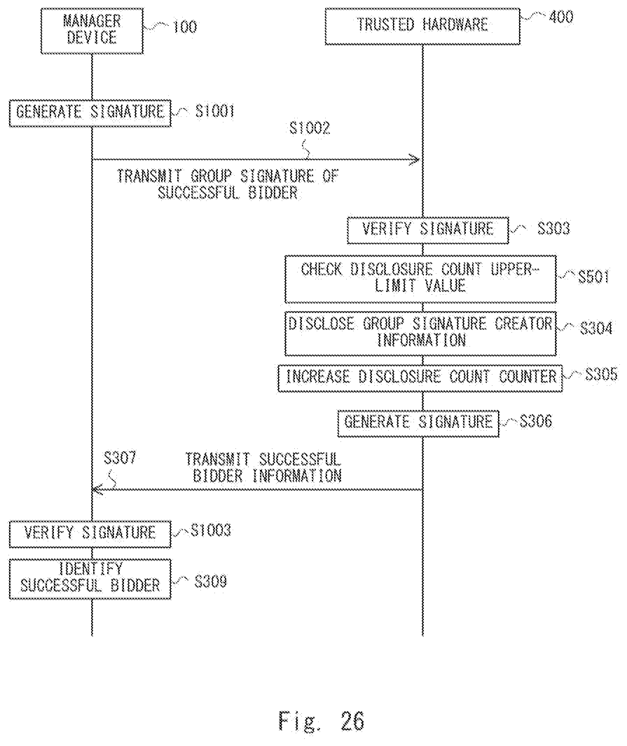

With reference to FIG. 26, an operation of identifying the bidder from the bid message will be described. In the following description, the detailed description of the steps already described above will be omitted. While the communication processing in the identifying operation according to the fourth example embodiment is different from that in the above example embodiments since the blockchain is used in the fourth example embodiment, the basic processing flow is similar to that in the aforementioned example embodiments.
(Step S1001) The blockchain controller 1020 of the manager device 100 grants the digital signature to the group signature for the bid message whose creator is to be identified.
(Step S1002) The blockchain controller 1020 of the manager device 100 transmits the message to which the digital signature has been applied in Step S1001 to the trusted hardware 40.
After Step S1002, the processing in Steps S303, S501, S304, S305, S306, and S307 is performed. After Step S307, the processing of Step S1003 is performed.
(Step S1003) The blockchain controller 1020 of the manager device 100 verifies the electronic signature granted to the received message.

After Step S1003, processing of Step S309 is performed.

The fourth example embodiment has been described above. In the fourth example embodiment, the administrator and the participants of the auction share information by the blockchain. That is, the bid message (bid information) and the price update message (update information) are shared by the manager device 100 and the participant device 90 by the blockchain. Therefore, the bid information and the update information can be shared transparently and in such a way that these information pieces cannot be tampered with. When a plurality of nodes (i.e., devices participating in the blockchain) have recorded the unauthorized information in the ledger, to what extent the ledger has tampering resistance against frauds depends on a consensus building protocol of the blockchain. In a case of Practical Byzantine Fault Tolerance (PBFT), which is a typical consensus building protocol, for example, the tampering resistance of the ledger is guaranteed only when the number of fraudulent nodes is equal to or smaller-than a third of all the nodes.

As a modified example of this example embodiment, a modified example that is similar to the modified example described in the third example embodiment may be achieved. That is, the participant device 90 may have a function of verifying the group signature granted to the bid message shared in the blockchain.

### (Other Modified Examples)

While the setup operation, the bidding operation, and the identifying operation have been mainly described in the above example embodiments, it is needless to say that an operation of determining the start and the end of the bidding may be added. There may be conditions such as time as conditions for determining the start and the end. When, for example, time is used as these conditions, a time server may be added to the auction system.

Further, as a matter of course, it may be possible to keep the communication content of the auction secret from third parties unrelated to the auction using public key encryption and common key encryption.

Further, the storage unit of the manager device may store data in an external data storage server or the like.

Further, while the trusted hardware is described as an external device that is connected to the manager device in such a way that they can communicate with each other in the example embodiments, the trusted hardware may actually be included in the manager device, like in SGX available from Intel or TrustZone available from ARM.

While the first and second example embodiments have been described taking the group signature disclosed in Non-Patent Literature 1 as an example, it is needless to say that another group signature system may instead be used. This group signature system includes a group signature system in which members of a group may be added later or expelled from the group. In this case, a controller for adding or expelling participants of the auction may be included in the manager device. Further, this controller may be provided in the outside of the manager device as a server device.

Further, as a matter of course, a function in which a participant cancels the bid that he/she has placed may be provided as necessary.

Further, as a matter of course, an English auction in which a group signature which is combined with dynamic accumulator and of which the anonymity level is higher than a general group signature system is used may be achieved. The dynamic accumulator is conceived by Camenisch and Lysyanskaya based on an accumulator scheme in 2002, in which it is demonstrated that a group signature with high anonymity can be achieved by a combination with the group signature. When the English auction that uses the group signature combined with the dynamic accumulator is achieved, a probabilistically encrypted ID may be attached to a message created by the user and its decryption key may be held by the trusted hardware.

Further, the English auction system proposed in Non-Patent Literature 4 may also be achieved. In this case, information written on a public bulletin board for an auction manager or a disclosure manager included in the system disclosed in Non-Patent Literature 4 may be recorded in the information sharing server 60 according to the third example embodiment or the blockchain according to the fourth example embodiment.

Further, the aforementioned program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been described with reference to the example embodiments, the present disclosure is not limited by the above example embodiments. Various changes that may be understood by those skilled in the art may be made to the configurations and the details of the present disclosure within the scope of the present disclosure.

The whole or a part of the exemplary embodiments disclosed above can be described as, but not limited to, the following supplementary notes.

### (Supplementary Note 1)

An information processing device comprising:

reception means for receiving signature information, which is information that constitutes an anonymous electronic signature;

identification information generation means for generating identification information, which is information for identifying a member that has created the anonymous electronic signature, based on the signature information;

storage means for storing the number of times the identification information is generated by the identification information generation means; and

transmission means for transmitting the identification information.

### (Supplementary Note 2)

The information processing device according to Supplementary Note 1, wherein

the reception means receives update information on a current evaluated value in an electronic auction, and

the transmission means transmits information in which the update information is associated with the current number of times of generation that has been stored.

### (Supplementary Note 3)

The information processing device according to Supplementary Note 2, further comprising signature generation means for generating a digital signature for the associated information,

wherein the transmission means transmits the associated information to which the digital signature has been granted.

### (Supplementary Note 4)

The information processing device according to any one of Supplementary Notes 1 to 3, wherein the identification information generation means generates the identification information when the number of times of generation that is stored is smaller than a predetermined upper-limit value.

### (Supplementary Note 5)

The information processing device according to Supplementary Note 4, wherein

the anonymous electronic signature is a signature granted to bid. information of an electronic auction, and

the upper-limit value is the maximum number of successful bidders in the electronic auction.

### (Supplementary Note 6)

The information processing device according to any one of Supplementary Notes 1 to 5, wherein the information processing device is a device that is guaranteed to include a mechanism for preventing leakage of data in the information processing device in advance.

### (Supplementary Note 7)

An information processing system comprising:

a management device that receives bid information with an anonymous electronic signature and manages bidding by an electronic auction and a disclosure device that identifies a participant device that is a member that has created the anonymous electronic signature, wherein

the management device comprises:

a first transmission means for transmitting, to the disclosure device, signature information, which is information that constitutes the anonymous electronic signature granted to the bid information regarding which the participant device which has transmitted the bit information should be identified among the pieces of bid information that have been received; and

a first reception means for receiving, from the disclosure device, identification information, which is information for identifying the participant device that has created the anonymous electronic signature,

the disclosure device comprises:

a second reception means for receiving the signature information from the management device;

identification information generation means for generating the identification information based on the signature information received by the second reception means;

storage means for storing the number of times the identification information is generated by the identification information generation means; and a second transmission means for transmitting the identification information to the management device.

### (Supplementary Note 8)

The information processing system according to Supplementary Note 7, wherein

the first transmission means transmits, when a current evaluated value in the electronic auction is updated, update information on an evaluated value to the disclosure device,

the second reception means receives the update information from the management device, and

the second transmission means transmits information in which the update information is associated with the current number of times of generation that has been stored.

### (Supplementary Note 9)

The information processing system according to Supplementary Note 8, wherein the bid information and the update information are shared by the management device and the participant device.

### (Supplementary Note 10)

The information processing system according to Supplementary Note 9, wherein the bid information and the update information are shared by the management device and the participant device by a blockchain.

### (Supplementary Note 11)

The information processing system according to Supplementary Note 9 or 10, wherein

the anonymous electronic signature granted to the bid information is shared as well,

the information processing system further includes the participant device, and

the participant device includes verification means for verifying the anonymous electronic signature.

### (Supplementary Note 12)

A member identification method, wherein

an information processing device performs processing of:

receiving signature information, which is information that constitutes an anonymous electronic signature;

generating, based on the signature information, identification information, which is information for identifying a member that has created the anonymous electronic signature;

storing the number of times the identification information is generated; and

transmitting the identification information.

### (Supplementary Note 13)

A non-transitory computer readable medium storing a program for causing a computer to execute the following steps of:

a receiving step for receiving signature information, which is information that constitutes an anonymous electronic signature;

an identification information generation step for generating identification information, which is information for identifying a member that has created the anonymous electronic signature based on the signature information;

a storing step for storing the number of times the identification information is generated; and

a transmission step for transmitting the identification information,

### REFERENCE SIGNS LIST

1 Information Processing System
2 Management Device
3 Disclosure Device
4, 9 Transmitter
5, 6 Receiver
7 Identification Information Generation Unit
8 Storage Unit
10, 50, 100 Manager Device
11, 13, 14 Auction System
15 Group Manager
16 Privileged Person
17 Group Member
20, 40 Trusted Hardware
30, 70, 90 Participant Device
60 Information Sharing Server
80 Network
110, 210, 310, 610, 910, 1010 Controller
111, 215, 314 Parameter Setting Unit
112, 212, 311 Signature Key Pair Generation Unit
113, 213, 312, 911 Signature Generation Unit
114, 214, 313, 1011 Signature Verification Unit
115 Price Verification Unit
116 Group Signature Creator Confirmation Unit
120, 220, 320, 420, 520, 630 Storage Unit
121 Data Storage Unit
122 Bid Information Storage Unit
123, 222, 321 Signature Verification Key Storage Unit
130, 230, 330, 530, 620, 720 Communication Unit
131, 231, 331, 431 Information Communication Unit
150 Network Interface
151 Memory
152 Processor
211, 411 Data Disclosure Unit
216 Disclosure Count Grant Message Generation
221, 322, 421 Disclosure Count Storage Unit
315 Bid Message Generation Unit
316 Count Value Verification Unit
423 Disclosure Count Upper-limit Value Storage Unit
531, 621, 721 Shared Information Communication Unit
631 Shared Information Storage Unit
920, 1020 Blockchain Controller

What is claimed is:

1. An information processing device comprising:
at least one memory storing program instructions; and
at least one processor configured to execute the instructions stored in the memory to:
receive signature information, which is information that constitutes an anonymous electronic signature;
generate identification information, which is information for identifying a member that has created the anonymous electronic signature, based on the signature information;
store the number of times the identification information is generated; and
transmit the identification information.

2. The information processing device according to claim 1, wherein
the processor is further configured to execute the instructions to:
receive update information on a current evaluated value in an electronic auction, and
transmit information in which the update information is associated with the current number of times of generation that has been stored.

3. The information processing device according to claim 2, wherein
the processor is further configured to execute the instructions to:
generate a digital signature for the associated information, and
transmit the associated information to which the digital signature has been granted.

4. The information processing device according to claim 1, wherein the processor is further configured to execute the instructions to generate the identification information when the number of times of generation that is stored is smaller than a predetermined upper-limit value.

5. The information processing device according to claim 4, wherein
the anonymous electronic signature is a signature granted to bid information of an electronic auction, and
the upper-limit value is the maximum number of successful bidders in the electronic auction.

6. The information processing device according to claim 1, wherein the information processing device is a device that is guaranteed to include a mechanism for preventing leakage of data in the information processing device in advance.

7. An information processing system comprising:
a management device that receives bid information with an anonymous electronic signature and manages bidding by an electronic auction and a disclosure device that identifies a participant device that is a member that has created the anonymous electronic signature, wherein
the management device comprises:
at least one first memory storing program instructions; and
at least one first processor configured to execute the instructions stored in the first memory to:
transmit, to the disclosure device, signature information, which is information that constitutes the anonymous electronic signature granted to the bid information regarding which the participant device which has transmitted the bit information should be identified among the pieces of bid information that have been received; and
receive, from the disclosure device, identification information, which is information for identifying the participant device that has created the anonymous electronic signature,
the disclosure device comprises:
at least one second memory storing program instructions; and
at least one second processor configured to execute the instructions stored in the second memory to:
receive the signature information from the management device;
generate the identification information based on the received signature information;
store the number of times the identification information is generated; and
transmit the identification information to the management device.

8. The information processing system according to claim 7, wherein
the first processor is further configured to execute the instructions stored in the first memory to transmit, when a current evaluated value in the electronic auction is updated, update information on an evaluated value to the disclosure device, and
the second processor is further configured to execute the instructions stored in the second memory to:
receive the update information from the management device; and
transmit information in which the update information is associated with the current number of times of generation that has been stored.

9. The information processing system according to claim 8, wherein the bid information and the update information are shared by the management device and the participant device.

10. The information processing system according to claim 9, wherein the bid information and the update information are shared by the management device and the participant device by a blockchain.

11. The information processing system according to claim 9, wherein
the anonymous electronic signature granted to the bid information is shared as well, and
the information processing system further includes the participant device including:
at least one third memory storing program instructions: and
at least one third processor configured to execute the instructions stored in the third memory to
verify the anonymous electronic signature.

12. A member identification method, wherein
an information processing device performs processing of:
receiving signature information, which is information that constitutes an anonymous electronic signature;
generating, based on the signature information, identification information, which is information for identifying a member that has created the anonymous electronic signature;
storing the number of times the identification information is generated; and
transmitting the identification information.

13. A non-transitory computer readable medium storing a program for causing a computer to execute the following steps of:
a receiving step for receiving signature information, which is information that constitutes an anonymous electronic signature;
an identification information generation step for generating identification information, which is information for identifying a member that has created the anonymous electronic signature based on the signature information;
a storing step for storing the number of times the identification information is generated; and
a transmission step for transmitting the identification information.
